(19) United States
(12) Patent Application Publication
(10) Pub. No.: US 2026/0126734 A1
(43) Pub. Date: May 7, 2026

(54) IMAGE FORMING APPARATUS

(71) Applicant: CANON KABUSHIKI KAISHA, Tokyo (JP)

(72) Inventors: ISAO KOISHI, Kanagawa (JP); YUKIO KUBO, Tokyo (JP); SHUNSUKE HIJIKATA, Kanagawa (JP); NAOKI HAYASHI, Kanagawa (JP); YUUJI OBUKURO, Saitama (JP); YU FUKASAWA, Tokyo (JP)

(21) Appl. No.: 19/370,351

(22) Filed: Oct. 27, 2025

(30) Foreign Application Priority Data
Nov. 5, 2024 (JP) 2024-194023

(51) Int. Cl. G03G 15/01; G03G 15/08; G03G 21/16

(52) U.S. Cl. CPC G03G 15/0121; G03G 15/0189; G03G 15/0808; G03G 15/0875; G03G 15/0886; G03G 15/0891; G03G 21/1619

(57) ABSTRACT

Provided are development units to which toner is supplied from toner replenishment containers through toner supply pipes, to miniaturize a main body by changing toner supply positions in the development units in longitudinal directions of development rollers, to reduce the numbers of exclusive components included in the development units. One end of a first passage communicates with a first space of a first development container through a first through-hole, one end of a second passage communicates with a second space of a second development container through a fourth through-hole, and a second through-hole of the first development container and a third through-hole of the second development container are sealed.

### BACKGROUND

### Field of the Technology

The present disclosure relates to an image forming apparatus using an electrophotographic method.

### Description of the Related Art

In a color image forming apparatus using an electrophotographic method, a configuration is known in which toner is conveyed to a development container in the image forming apparatus by providing a conveyance mechanism using air in the image forming apparatus.

Japanese Patent Laid-Open No. 2024-132973 discusses a configuration in which air supplied from a pump is mixed with toner, and the air and the toner are conveyed to a development container.

### SUMMARY

An aspect of the present disclosure provides an image forming apparatus that includes a first toner container configured to store first toner, the first toner container including a first discharge port for discharge of the first toner, a second toner container configured to store second toner, the second toner container including a second discharge port for discharge of the second toner; a first development unit including a first development container configured to store the first toner, the first development unit including a first development roller configured to bear the first toner stored in the first development container; a second development unit including a second development container configured to store the second toner, the second development unit including a second development roller configured to bear the second toner; a first passage configured to convey the first toner discharged from the first discharge port toward the first development container, wherein one end of the first passage communicates with the first discharge port of the first toner container and another end of the first passage communicates with the first development container; and a second passage configured to convey the second toner discharged from the second discharge port toward the second development container, wherein one end of the second passage communicates with the second discharge port of the second toner container and another end of the second passage communicates with the second development container. The first development container includes a first frame, which forms a first space configured to store the first toner, with a first through-hole and a second through-hole provided in the first frame. The second development container includes a second frame, which forms a second space configured to store the second toner, with a third through-hole and a fourth through-hole corresponding to the first through-hole and the second through-hole, respectively, provided in the second frame. The other end of the first passage communicates with the first space of the first development container through the first through-hole. The other end of the second passage communicates with the second space of the second development container through the fourth through-hole. The second through-hole and the third through-hole are sealed.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are a top view and a front view, respectively, of a development unit according to a first embodiment.

FIG. 2 is a cross-sectional view of an image forming apparatus according to the first embodiment.

FIGS. 3A to 3C are perspective views of the image forming apparatus according to the first embodiment.

FIGS. 4A and 4B are perspective views of an image forming unit according to the first embodiment.

FIG. 5 is a perspective view illustrating laser optical paths of the image forming unit according to the first embodiment.

FIGS. 6A and 6B are top views of the image forming unit and a laser scanner according to the first embodiment.

FIGS. 7A and 7B are cross-sectional views of the image forming unit and the laser scanner perpendicular to rotational axes of drums according to the first embodiment.

FIGS. 8A and 8B are cross-sectional views of the image forming unit and the laser scanner parallel to the rotational axes of the drums according to the first embodiment.

FIG. 9 is a perspective view of the image forming unit in a state where the image forming unit is pulled out of an apparatus main body according to the first embodiment.

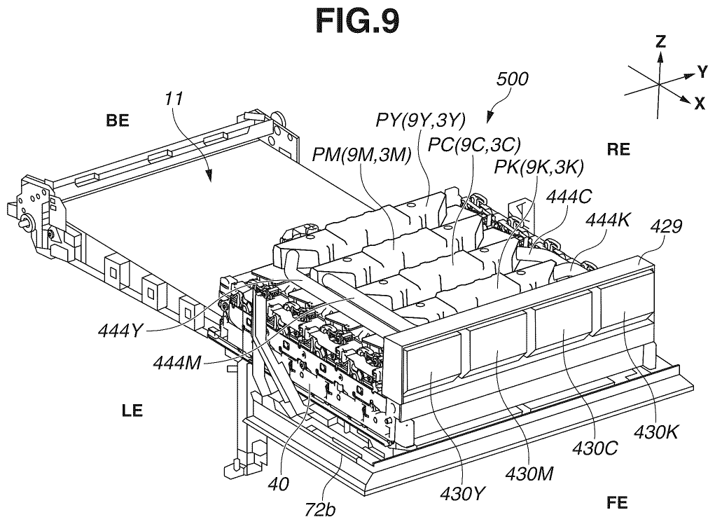

FIGS. 10A to 10E are a front view, a top view, a bottom view, a side view, and a rear view, respectively, of a cartridge according to the first embodiment.

FIGS. 11A to 11C are a cross-sectional view, a perspective view, and an exploded perspective view, respectively, of the cartridge according to the first embodiment.

FIGS. 12A and 12B are a cross-sectional view and a perspective view, respectively, of the cartridge according to the first embodiment.

FIGS. 13A and 13B are an exploded perspective view and a perspective view, respectively, of a development unit according to the first embodiment.

FIG. 14 is a perspective view of a process cartridge according to the first embodiment.

FIG. 15 is a perspective view of a relay member according to the first embodiment.

FIGS. 16A and 16B are an exploded perspective view and a perspective view, respectively, of a development unit according to the first embodiment.

FIG. 17 is a perspective view of a sealing cap according to the first embodiment.

FIGS. 18A and 18B are an exploded perspective view and a perspective view, respectively, of a development unit according to the first embodiment.

FIGS. 19A and 19B are an exploded perspective view and a perspective view, respectively, of the development unit according to the first embodiment.

FIG. 20 is a perspective view illustrating the laser optical paths of the image forming unit according to the first embodiment.

FIG. 21 is a top view illustrating the laser optical paths of the image forming unit according to the first embodiment.

FIGS. 22A and 22B are a top view and a front view, respectively, of a development unit according to a second embodiment.

FIGS. 23A and 23B are an exploded perspective view and a perspective view, respectively, of the development unit according to the second embodiment.

FIG. 24 is a perspective view of a development unit according to the second embodiment.

FIG. 25 is a perspective view of the development unit according to the second embodiment.

FIG. 26 is a perspective view of the development unit according to the second embodiment.

FIGS. 27A and 27B are a top view and a front view, respectively, of a relay member according to the second embodiment.

FIGS. 28A and 28B are a top view and a front view, respectively, of a development unit according to a third embodiment.

FIGS. 29A and 29B are an exploded perspective view and a perspective view, respectively, of the development unit according to the third embodiment.

FIGS. 30A and 30B are side views of the development unit according to the first embodiment.

FIGS. 31A and 31B are schematic side views of the development unit according to the first embodiment.

### DESCRIPTION OF THE EMBODIMENTS

### First Embodiment

### Image Forming Apparatus

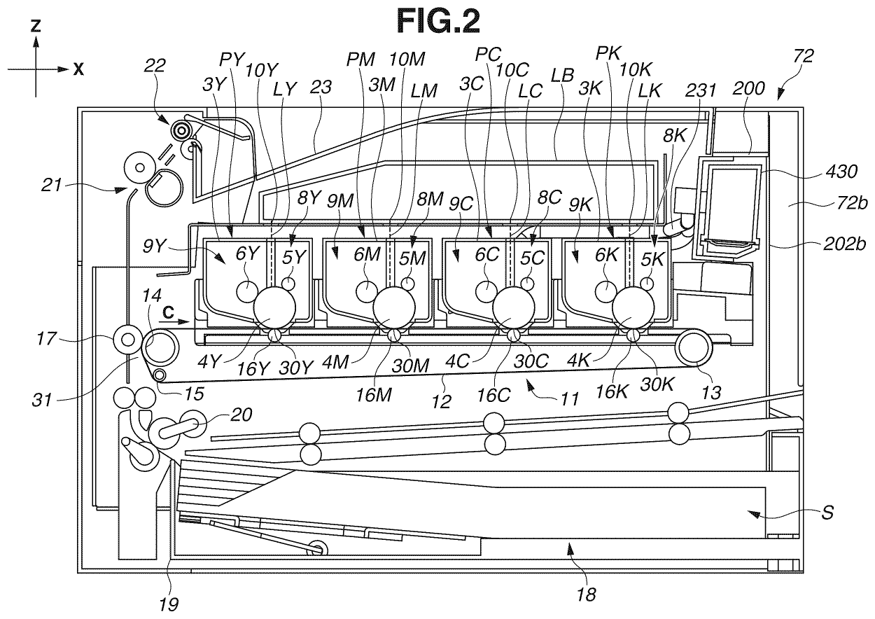

With reference to FIG. 2, an image forming apparatus 1 according to a first embodiment of the present disclosure is described. The image forming apparatus 1 using an electrophotographic method according to the present embodiment is a full-color image forming apparatus including process units for four colors. FIG. 2 is the principal section of the image forming apparatus 1.

The image forming apparatus 1 is a full-color laser printer using an electrophotographic process capable of forming a full-color image on a recording medium S. The image forming apparatus 1 includes an apparatus main body 72 and process units PY, PM, PC, and PK (also referred to as process unit P; Y, M, C, or K, with the suffix representing the toner color, i.e. Y representing yellow, M representing magenta, C representing cyan, and K representing black; wit similar nomenclature applying to other components. The process units P are aligned in a first direction X, and the colors of the toner stored inside the process units P are different from each other. The longitudinal directions of the process units P are a second direction Y perpendicular to the first direction X. The process units PY, PM, PC, and PK are a first process unit, a second process unit, a third process unit, and a fourth process unit, respectively.

The process units P include electrophotographic process elements. To each process unit P, a rotational driving force is transmitted from a drive output section of the apparatus main body 72, and a bias voltage (a charging bias, a development bias, or the like) is supplied from a bias application section of the apparatus main body 72.

As illustrated in FIG. 2, the process units P, each composed of a drum unit and a development unit, include drum units 8Y, 8M, 8C, and 8K (hereinafter referred to as drum units 8). The drum units 8 include photosensitive drums 4Y, 4M, 4C, and 4K (hereinafter referred to as photosensitive drums 4) and charging rollers 5Y, 5M, 5C, and 5K (hereinafter referred to as charging rollers 5) as process methods for acting on the photosensitive drums 4. The photosensitive drums 4 are placed so that the directions of the rotational axes of the photosensitive drums 4 are provided along the second direction Y. The photosensitive drums 4Y, 4M, 4C, and 4K are a first photosensitive drum, a second photosensitive drum, a third photosensitive drum, and a fourth photosensitive drum, respectively.

The process units P include development units 9Y, 9M, 9C, and 9K (hereinafter referred to as development units 9) including development rollers 6Y, 6M, 6C, and 6K (hereinafter referred to as development rollers 6), respectively, that develop electrostatic latent images on the corresponding photosensitive drums 4. The development units 9 are aligned along the first direction X. The development rollers 6Y, 6M, 6C, and 6K are a first development roller, a second development roller, a third development roller, and a fourth development roller, respectively. The development units 9Y, 9M, 9C, and 9K are a first development unit, a second development unit, a third development unit, and a fourth development unit, respectively.

The development unit 9Y includes a development container 3Y (first development container) as a toner storage container that stores yellow (Y) toner (first toner). The development unit 9Y is configured so that the development roller 6Y bearing the yellow (Y) toner supplies the yellow (Y) toner to the surface of the photosensitive drum 4Y. The development unit 9M includes a development container 3M (second development container) that stores magenta (M) toner (second toner). The development unit 9M is configured so that the development roller 6M bearing the magenta (M) toner supplies the magenta (M) toner to the surface of the photosensitive drum 4M. The development unit 9C includes a development container 3C (third development container) that stores cyan (C) toner (third toner). The development unit 9C is configured so that the development roller 6C bearing the cyan (C) toner supplies the cyan (C) toner to the surface of the photosensitive drum 4C. The development unit 9K includes a development container 3K (fourth development container) that stores black (K) toner (fourth toner). The development unit 9K is configured so that development roller 6K bearing the black (K) toner supplies the black (K) toner to the surface of the photosensitive drum 4K.

In a third direction Z that is the direction of gravity intersecting both the first direction X and the second direction Y, a laser scanner unit LB (exposure unit) is provided above the process units P (photosensitive drums 4). The laser scanner unit LB outputs laser light corresponding to image information. The optical paths of the laser light directed to the photosensitive drums 4Y, 4M, 4C, and 4K are optical paths LY, LM, LC, and LK, respectively (hereinafter referred to as optical path(s) L). Then, the laser light passes through exposure windows 10Y, 10M, 10C, and 10K of the laser scanner unit LB, and scans and exposes the surfaces of the photosensitive drums 4. Instead of the laser scanner unit LB, a light-emitting diode (LED) exposure unit may be used.

In the third direction Z, an intermediate transfer belt unit 11 as a transfer member is provided below the process units P. The intermediate transfer belt unit 11 includes a driving roller 14, a tension roller 13, and an assist roller 15, and a flexible transfer belt 12 is stretched around these rollers.

Each of the lower surfaces of the photosensitive drums 4 is in contact with the upper surface of the transfer belt 12. Contact portions between the photosensitive drums 4 and the transfer belt 12 are primary transfer portions 30Y, 30M, 30C, and 30K (also referred to as primary transfer portions 30). Inside the transfer belt 12, primary transfer rollers 16Y, 16M, 16C, and 16K (also referred to as transfer rollers 16) are provided opposed to the photosensitive drums 4.

The driving roller 14 is pressed by a secondary transfer roller 17 through the transfer belt 12. A contact portion between the transfer belt 12 and the secondary transfer roller 17 is a secondary transfer portion 31.

In the third direction Z, a feeding unit 18 is provided below the intermediate transfer belt unit 11. The feeding unit 18 includes a sheet feeding tray 19 that stacks and stores recording media S, and a sheet feeding roller 20 that picks up each of the recording media S from the sheet feeding tray 19 and conveys the recording medium S.

In an upper portion of the apparatus main body 72 in FIG. 2, a fixing unit 21 that fixes a toner image to the recording medium S, and a discharge roller 22 that discharges the recording medium S to which the toner image is fixed to a discharge tray 23 are provided. The discharge roller 22 discharges the recording medium S in a direction along the first direction X. In the present embodiment, the downstream side in the discharge direction in which the recording medium S is discharged toward the discharge tray 23 by the discharge roller 22 is the front surface side of the image forming apparatus 1, and the upstream side in the discharge direction is the back surface side of the image forming apparatus 1.

### Image Forming Operation

An image forming operation for forming a full-color image is as described below. The photosensitive drums 4 are rotationally driven counterclockwise in FIG. 2 at a predetermined speed. The transfer belt 12 is rotationally driven in a forward direction (the direction of an arrow C in FIG. 2) relative to the rotation of the photosensitive drums 4 at a speed corresponding to the rotational speed of the photosensitive drums 4.

The laser scanner unit LB is also driven. In synchronization with the driving of the laser scanner unit LB, the charging rollers 5 uniformly charge the surfaces of the corresponding photosensitive drums 4 to a predetermined polarity and a predetermined potential in the process units P. The laser scanner unit LB scans and exposes the charged surfaces of the photosensitive drums 4 with laser light according to image signals of the respective colors. Consequently, electrostatic latent images according to the image signals of the respective colors are formed on the surfaces of the photosensitive drums 4. As described above, the laser scanner unit LB exposes the photosensitive drums 4Y and 4M, and a first electrostatic latent image and a second electrostatic latent image are formed on the photosensitive drums 4Y and 4M, respectively. Similarly, the laser scanner unit LB exposes the photosensitive drums 4C and 4K, and a third electrostatic latent image and a fourth electrostatic latent image are formed on the photosensitive drums 4C and 4K, respectively.

The electrostatic latent images on the photosensitive drums 4 are developed by the development rollers 6 supplying toner to the photosensitive drums 4 while the development rollers 6 are rotationally driven clockwise in FIG. 2 at a predetermined speed.

By the above image forming process using the electrophotographic method, a yellow toner image is formed on the photosensitive drum 4Y of the process unit PY. Then, the yellow toner image is primarily transferred onto the transfer belt 12.

Regarding magenta, a magenta toner image is similarly formed on the photosensitive drum 4M of the process unit PM. Then, the magenta toner image is primarily transferred onto the transfer belt 12 in a superimposed manner on the yellow toner image on the transfer belt 12.

Regarding cyan, similarly, a cyan toner image is similarly formed on the photosensitive drum 4C of the process unit PC. Then, the cyan toner image is primarily transferred onto the transfer belt 12 in a superimposed manner on the yellow and magenta toner images on the transfer belt 12.

Regarding black, similarly, a black toner image is similarly formed on the photosensitive drum 4K of the process unit PK. Then, the black toner image is primarily transferred onto the transfer belt 12 in a superimposed manner on the yellow, magenta, and cyan toner images on the transfer belt 12.

In this manner, a full-color unfixed toner image of the four colors, namely yellow, magenta, cyan, and black, is formed on the transfer belt 12.

At a predetermined control timing, recording media S are separated one by one from the sheet feeding tray 19 and fed by the sheet feeding roller 20. At a predetermined control timing, the recording medium S is introduced into the secondary transfer portion 31, which is the contact portion between the secondary transfer roller 17 and the transfer belt 12. During the process in which the recording medium S is conveyed in the secondary transfer portion 31, the toner image of the four colors superimposed on the transfer belt 12 is transferred to the recording medium S. The recording medium S to which the toner image is transferred is heated and pressurized by the fixing unit 21, and the toner image is fixed to the recording medium S. The recording medium S to which the toner image is fixed is discharged to the discharge tray 23 by the discharge roller 22.

The image forming apparatus 1 includes cartridges 430Y, 430M, 430C, and 430K as toner replenishment containers attachable to and detachable from the apparatus main body 72. Hereinafter, the cartridges 430Y, 430M, 430C, and 430K are referred to as cartridges 430. FIG. 2 illustrates a state where the cartridges 430 are aligned and overlap each other in the second direction Y. FIG. 2 representatively illustrates cartridges 430 aligned in the second direction Y, and the direction in which the cartridges 430 are aligned intersects (is orthogonal to) the direction in which the development units 9 are aligned.

The cartridges 430Y, 430M, 430C, and 430K are a first cartridge (first toner container), a second cartridge (second toner container), a third cartridge (third toner container), and a fourth cartridge (fourth toner container), respectively.

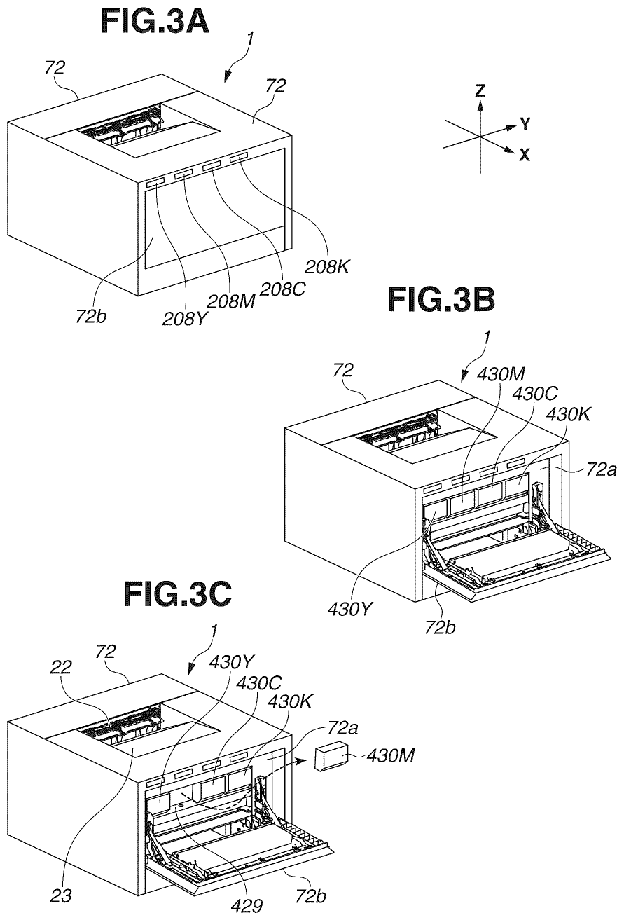

FIG. 3A is a perspective view of the image forming apparatus 1 in the state where a front door 72b is closed. FIG. 3B is a perspective view of the image forming apparatus 1 in the state where the front door 72b is opened. FIG. 3C is a perspective view of the image forming apparatus 1 in the state where the cartridge 430M is removed from a cartridge holder 429 in the state where the front door 72b is opened.

The cartridges 430 are attached to an upper portion on the front surface side of the apparatus main body 72 so that the cartridges 430 can be accessed by opening the front door 72b. The position where the cartridges 430 are attached is also an end portion of the apparatus main body 72 on the downstream side in the discharge direction of a recording medium S discharged by the discharge roller 22.

The front door 72b is configured to be movable between a closed position where an opening 72a (see FIGS. 3B, 3C) of the apparatus main body 72 on the front surface side is closed (see FIG. 3A) and an opened position where the opening 72a is opened (see FIGS. 3B, 3C). If the front door 72b is moved to the opened position, then as illustrated in FIG. 3B, the cartridges 430 are exposed to outside the image forming apparatus 1 through the opening 72a.

The cartridges 430 are placed side by side in the second direction Y, and therefore are configured to be attachable to and detachable from the apparatus main body 72 in the first direction X, as illustrated in FIG. 3C. Consequently, it is possible to attach and detach the cartridges 430 that replenish toner to the process units P without detaching the process units P from the apparatus main body 72.

The cartridges 430 are placed on the front surface side of the image forming apparatus 1, for a user to access the cartridges 430 from the front surface side, similar to access for collecting recording media S discharged to the discharge tray 23.

The cartridge holder 429 is located on the front surface side of the image forming apparatus 1, and closer to the front surface side than the process units P. This results in a configuration in which, even after the cartridges 430 are detached, the process units P are not exposed (see FIGS. 2 and 3C).

The cartridges 430 are accommodated in the apparatus main body 72 in a state in which the front door 72b is closed.

As illustrated in FIG. 3A, indicators 208Y, 208M, 208C, and 208K (hereinafter referred to as indicators 208, indication sections or display sections) for respective colors are provided on the front surface of the image forming apparatus 1. The indicators 208 are arranged side by side in the second direction Y to correspond to a respective cartridge 430. The indicator 208Y (first indicator) indicates yellow, the indicator 208M (second indicator) indicates magenta, the indicator 208C (third indicator) indicates cyan, and the indicator 208K (fourth indicator) indicates black. The indicators 208 include LEDs or color seals that correspond to the colors of toner of the respective cartridges 430, and are provided to prevent the erroneous attachment of the cartridges 430. The indicators 208 may have the functions of displaying the remaining amounts of toner in the corresponding process units P (the development units 9).

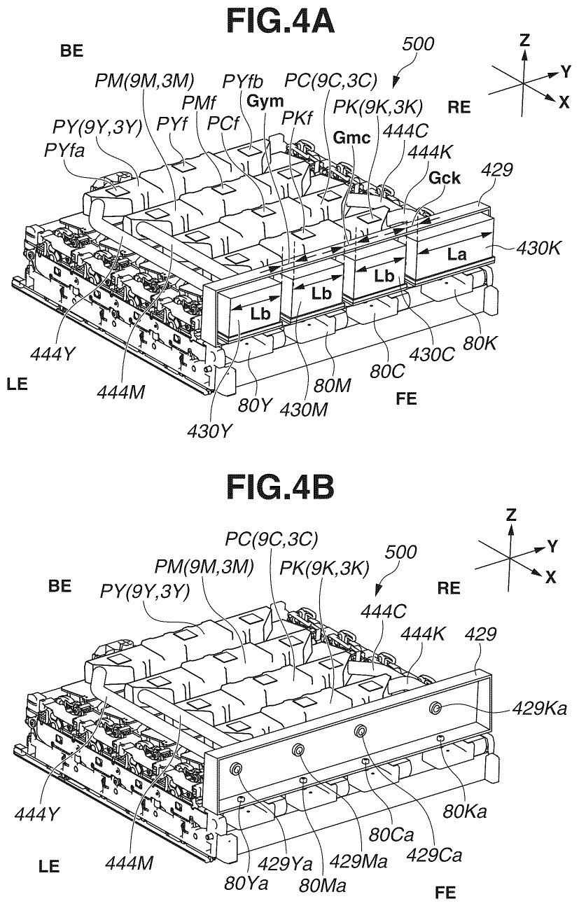

With reference to FIG. 4A to FIG. 8B, a description is given of a toner conveyance mechanism for conveying toner from the cartridges 430 to the corresponding process units P. An image forming unit 500 includes the cartridges 430, the process units P, and conveyance paths for conveying toner from the cartridges 430 to the process units P.

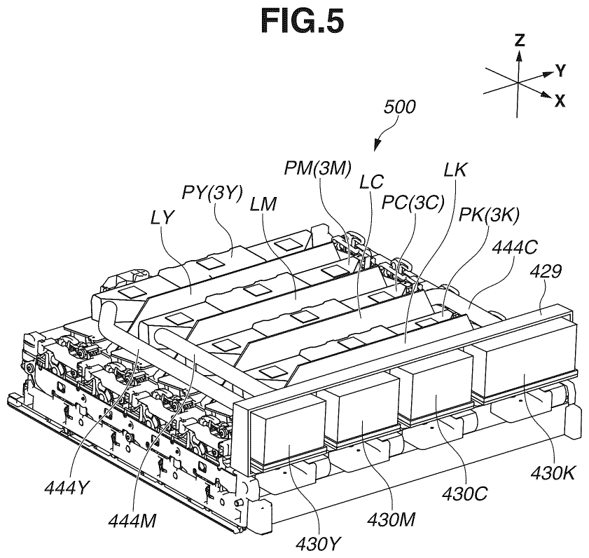

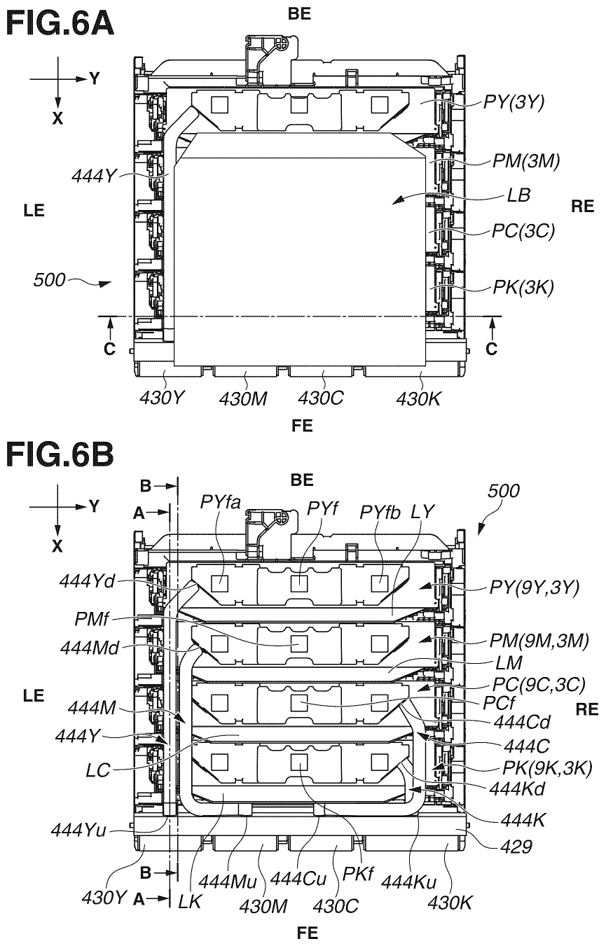

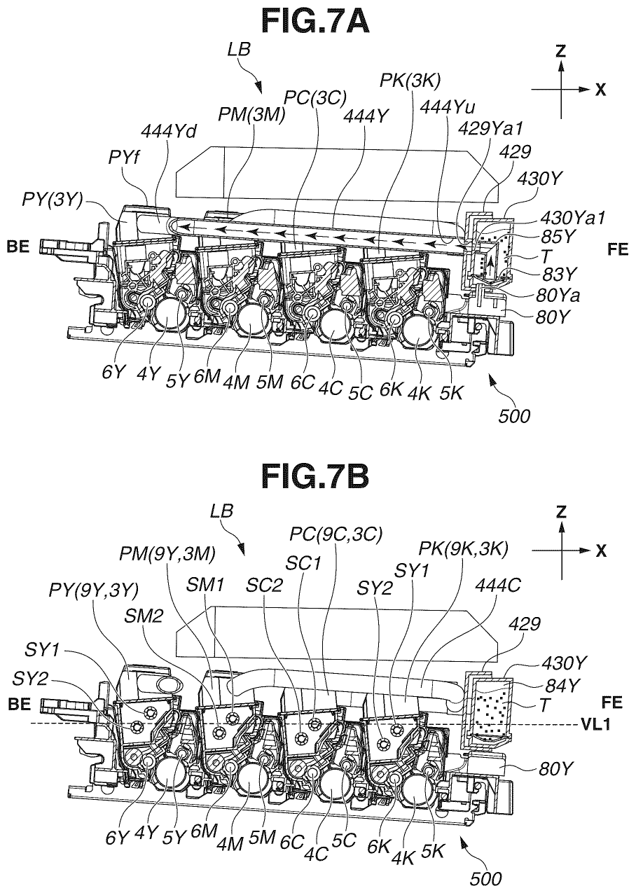

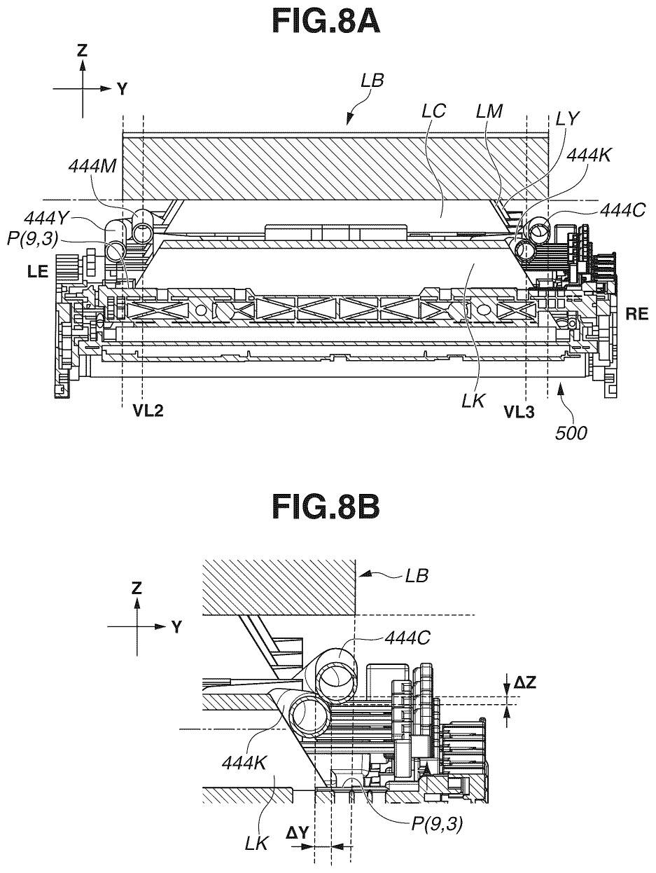

FIG. 4A is a perspective view of the image forming unit 500 in the state where the cartridges 430 are attached. FIG. 4B is a perspective view of the image forming unit 500 in the state where the cartridges 430 are detached. FIG. 5 is a perspective view illustrating the optical paths of laser light of the laser scanner unit LB in the image forming unit 500. FIG. 6A is a top view of the laser scanner unit LB and the image forming unit 500. FIG. 6B is a top view of the image forming unit 500. FIGS. 7A and 7B are a cross section A-A and a cross section B-B, respectively, in FIG. 6B. FIG. 8A is a cross section C-C in FIG. 6A.

FIG. 4A to FIG. 8B indicate a front surface side FE and a back surface side BE in the image forming unit 500. FIG. 4A to FIG. 8B also indicate a driving side RE where drive is mainly received from the main body 72, and a non-driving side LE opposite to the driving side RE.

As illustrated in FIGS. 4A and 5, pump units 80Y, 80M, 80C, and 80K (hereinafter referred to as pump units 80) corresponding to the respective colors are provided below the cartridge holder 429 that holds the cartridges 430. The pump units 80 are aligned in the second direction Y. The pump units 80Y, 80M, 80C, and 80K are a first pump unit, a second pump unit, a third pump unit, and a fourth pump unit, respectively. As each pump unit 80, a volumetric pump such as a reciprocating pump, a rotary pump, or the like is used. The reciprocating pump is a pump that performs suction and discharge by the reciprocation of a piston, a plunger, or the like. Examples of the reciprocating pump include a piston pump, a plunger pump, a diaphragm pump, and the like. The rotary pump is a pump that performs suction and discharge by rotationally moving a gear or a rotor. Examples of the rotary pump include a gear pump, a screw pump, a vane pump, and the like. The four pump units 80 may be configured as a single pump unit. Although in the present embodiment, the pump units 80 are provided in the apparatus main body 72, the pump units 80 may be provided in the cartridges 430.

As illustrated in FIGS. 4B and 7A, exposed openings are provided in portions of the cartridge holder 429 opposed to the lower surfaces of the cartridges 430. These openings are discharge outlets from which compressed air generated by the pump units 80 is discharged. The discharge outlets 80a open upward.

The air discharged upward from the discharge outlets 80a is supplied to inside the cartridges 430 attached to the cartridge holder 429. The air supplied to inside the cartridges 430 is discharged with toner from the cartridges 430 to outside. The internal structures of the cartridges 430 are described below.

The toner discharged with the air from the cartridges 430 is received by one end of a respective replenishment pipe 444 through reception ports 429Ya, 429Ma, 429Ca, and 429Ka (hereinafter referred to as reception ports 429a) provided in the cartridge holder 429, as illustrated in FIG. 4B. The replenishment pipes 444 are replenishment pipes 444Y, 444M, 444C, and 444K, as toner supply pipes. The replenishment pipes 444 extend to the development units 9, with ends of the replenishment pipes 444 connected to a respective development unit 9. The reception ports 429a are through-holes provided to penetrate through the surface of the cartridge holder 429 on a surface opposite to the back surfaces of the cartridges 430. The reception ports 429a open in the first direction X, which is the direction in which the development units 9 are arranged side by side. The direction in which the reception ports 429a open intersects with the direction in which the discharge outlets 80a open.

As illustrated in FIG. 6B, the replenishment pipes 444 are connected to positions corresponding to portions of the cartridge holder 429 where the reception ports 429a are provided. Upstream end portions 444Yu, 444Mu, 444Cu, and 444Ku (hereinafter referred to as upstream end portions) of the replenishment pipes 444 are connected to the cartridge holder 429 to communicate with the reception ports 429a.

The toner received from the reception ports 429a is conveyed and moves inside the replenishment pipes 444 from the upstream end portions to respective downstream end portions 444Yd, 444Md, 444Cd, and 444Kd (hereinafter referred to as downstream end portions 444d) by the air discharged from the cartridges 430 and is replenished to the development units 9.

The downstream end portions 444d of the replenishment pipes 444 are connected to end portions in the second direction Y of the development units 9. Specifically, the downstream end portion 444Yd of the replenishment pipe 444Y and the downstream end portion 444Md of the replenishment pipe 444M are connected to an end portion on the LE side of the development unit 9Y and an end portion on the LE side of the development unit 9M, respectively. The downstream end portion 444Cd of the replenishment pipe 444C and the downstream end portion 444Kd of the replenishment pipe 444K are connected to an end portion on the RE side of the development unit 9C and an end portion on the RE side of the development unit 9K, respectively, to shorten the length of each of the replenishment pipes 444, reduce pressure loss, allow for use of small-sized pump units as the pump units 80, and miniaturize the image forming unit 500.

Next, the placement of the cartridge 430Y is described. As illustrated in FIG. 7B, the cartridge 430Y and the process units P (the development units 9) are placed on a virtual line VL1 extending in the first direction X. That is, in the first direction X, the cartridge 430Y is aligned with the development units 9. In other words, when viewed in the first direction X, at least a part of the cartridge 430Y is overlaps the development units 9. In the first direction X, the cartridges 430M, 430C, and 430K are also aligned with the development units 9. In other words, when viewed in the first direction X, at least parts of the cartridges 430M, 430C, and 430K are placed to be overlapping with the development units 9. With this placement of the cartridges 430, it is possible to reduce the height in the third direction Z of the image forming apparatus 1. Thus, it is possible to miniaturize the image forming apparatus 1. In the third direction Z, the cartridges 430 may be located above the process units P (the development units 9).

Next, the placement of the replenishment pipes 444 is described. FIGS. 5, 6B, 8A, and 8B visualize the optical paths of laser light of the laser scanner unit LB for convenience. The optical paths LY, LM, LC, and LK (hereinafter referred to as optical paths L) illustrate laser light emitted from the laser scanner unit LB toward the photosensitive drums 4Y, 4M, 4C, and 4K, respectively.

The replenishment pipes 444 are placed not to interfere with the optical paths L. Specifically, as illustrated in FIGS. 6B and 8A, in the second direction Y, the replenishment pipes 444Y and 444M are provided in end portions on the LE side of the process units P by avoiding the optical paths L.

In the second direction Y, the replenishment pipe 444Y is placed outside the replenishment pipe 444M, i.e., further on the LE side than the replenishment pipe 444M.

As illustrated in FIG. 6A, when viewed from above in the third direction Z, at least a part of the replenishment pipe 444Y does not overlap the laser scanner unit LB. As illustrated in FIG. 6A, when viewed from above in the third direction Z, the replenishment pipe 444M overlaps the laser scanner unit LB.

As illustrated in FIG. 8A, in the third direction Z, the replenishment pipes 444Y and 444M are located below the laser scanner unit LB and located above the process units P (the development units 9 and the development containers 3). That is, in the third direction Z, the replenishment pipes 444Y and 444M are located between the position of the laser scanner unit LB and the position of the process units P. The closer to the process units P (photosensitive drums 4) and the further away from the laser scanner unit LB the optical paths L are, the greater the widths in the second direction Y of the optical paths L are. Thus, in the third direction Z, space is formed in a portion between the optical path LK and the laser scanner unit LB before the width in the second direction Y of the optical path LK increases. In the third direction Z, the replenishment pipe 444M is placed in the space between the optical path LK and the laser scanner unit LB. That is, as illustrated in FIG. 8A, when viewed in the first direction X, the laser scanner unit LB, the replenishment pipe 444M, and the optical path LK are located on a virtual line VL2 extending in the third direction Z.

Next, as illustrated in FIGS. 6B, 8A, and 8B, in the second direction Y, the replenishment pipes 444C and 444K are provided in end portions on the RE side of the process units P by avoiding the optical paths L. That is, in the second direction Y, the replenishment pipes 444C and 444K are located in the end portions on the opposite side of the end portions where the replenishment pipes 444Y and 444M are located. In the second direction Y, the replenishment pipe 444C is placed outside the replenishment pipe 444K, i.e., further on the RE side than the replenishment pipe 444K.

As illustrated in FIG. 6A, when viewed from above in the third direction Z, both the replenishment pipes 444C and 444K overlap the laser scanner unit LB. In FIG. 6A, the replenishment pipes 444C and 444K are not visible beneath the laser scanner unit LB.

As illustrated in FIG. 8B, the replenishment pipes 444C and 444K are located below the laser scanner unit LB and located above the process units P (the development units 9 and the development containers 3). That is, in the third direction Z, the replenishment pipes 444C and 444K are located between the position of the laser scanner unit LB and the position of the process units P. In the third direction Z, the replenishment pipe 444K is located in the space between the optical path LK and the laser scanner unit LB.

As illustrated in FIG. 8A, when viewed in the first direction X, the laser scanner unit LB, the replenishment pipe 444K, and the optical path LK are located on a virtual line VL3 extending in the third direction Z.

As illustrated in FIG. 8B, the replenishment pipe 444C is located above the replenishment pipe 444K. The replenishment pipe 444C overlaps the replenishment pipe 444K by ΔY in the direction Y, and the replenishment pipe 444C overlaps the replenishment pipe 444K by ΔZ in the direction Z.

The replenishment pipes 444 are placed as described above, whereby it is possible to miniaturize the image forming unit 500 in the second direction Y or the third direction Z. The replenishment pipes 444 do not necessarily need to be placed as described above.

The image forming unit 500 may have a configuration in which a person may readily access the process units P and the replenishment pipes 444 to maintain and replace the process units P, the replenishment pipes 444, and the like in a service response when a failure occurs or the like. Accordingly, in the present embodiment, the image forming unit 500 is configured to be able to be pulled out of the apparatus main body 72 (the intermediate transfer belt unit 11) from the BE side (the back surface side) to the FE side (the front surface side). The image forming apparatus 1 may have a configuration in which the image forming unit 500 cannot be pulled out.

### Structures of Cartridges

With reference to FIG. 4A and FIGS. 10A to 12, the structures of the cartridges 430 (the toner containers) according to the present embodiment are described.

As illustrated in FIG. 4A, a width La in the second direction Y of the cartridge 430K is wider than a width Lb of each of the cartridges 430Y, 430M, and 430C (hereinafter referred to as cartridges 430Y to 430C). Thus, the volume for storing toner in the cartridge 430K is greater than the volume for storing toner in each of the cartridges 430Y to 430C. Black toner, which is generally consumed more, can be stored more than toner of the other colors, to equalize the numbers of times of replacement of the cartridges 430Y, 430M, 430C, and 430K. Since the structures of the cartridges 430 are the same as each other, except for the widths in the second direction Y, the structure of the cartridge 430Y is described, with the description of the structures of the cartridges 430M, 430C, and 430K is incorporated herein by reference, for conciseness.

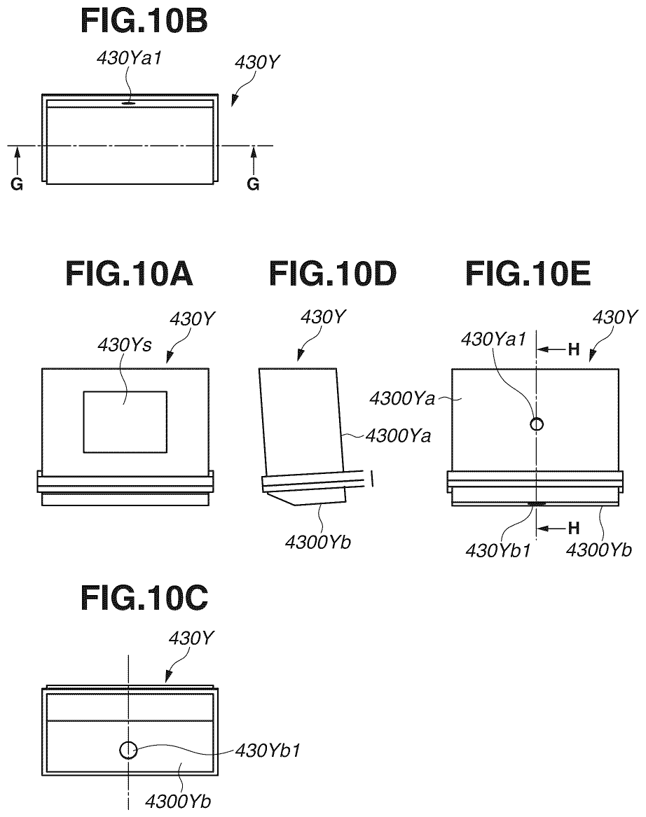

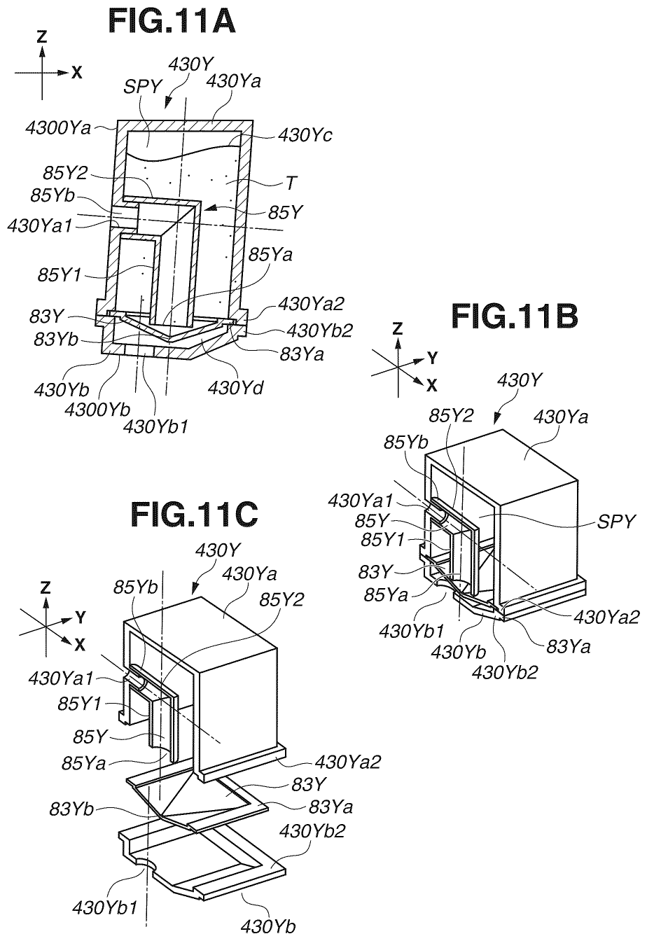

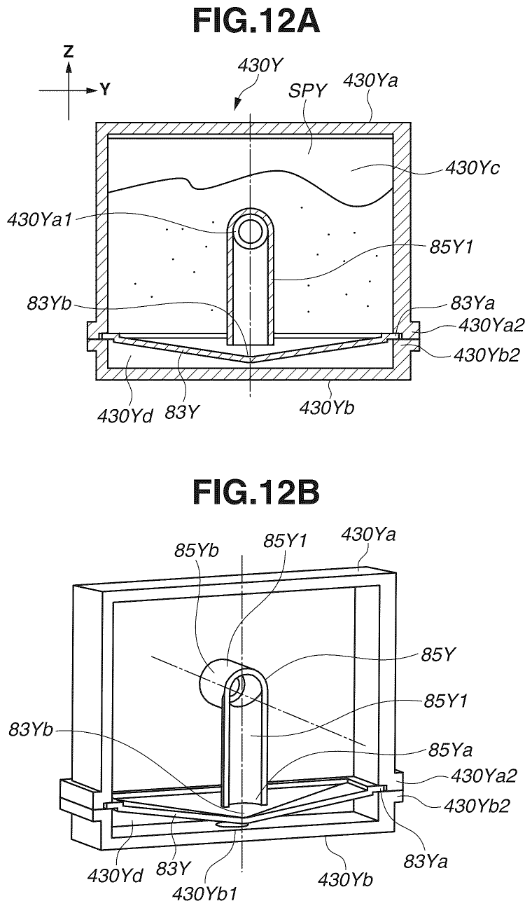

FIGS. 10A, 10B, 10C, 10D, and 10E are a front view, a top view, a bottom view, a right side view, and a rear view, respectively, of the cartridge 430Y. FIG. 11A is a cross-sectional view along H-H in FIG. 10E. FIG. 11B is a perspective view of the cartridge 430Y. FIG. 11C is an exploded perspective view of the cartridge 430Y. FIG. 12A is a cross-sectional view along G-G in FIG. 10B. FIG. 12B is a perspective view of FIG. 12A. The following description of the structure of the cartridge 430Y is based on a state (orientation) where the cartridge 430Y is attached to the cartridge holder 429.

As illustrated in FIGS. 11A to 11C, the cartridge 430Y includes a first frame 430Ya, a second frame 430Yb, a filter 83Y (a first filter or a first ventilation member), and a discharge pipe 85Y (a first discharge pipe or a first passage).

Similarly, the cartridge 430M includes a third frame, a fourth frame, a filter (a second filter or a second ventilation member), and a discharge pipe (a second discharge pipe or a second passage).

Similarly, the cartridge 430C includes a fifth frame, a sixth frame, a filter (a third filter or a third ventilation member), and a discharge pipe (a third discharge pipe or a third passage).

Similarly, the cartridge 430K includes a seventh frame 430Ka, an eighth frame 430Kb, a filter 83K (a fourth filter or a fourth ventilation member), and a discharge pipe 85K (a fourth discharge pipe or a fourth passage).

Each of the first frame 430Ya and the second frame 430Yb according to the present embodiment is a member molded with a resin, but may be formed of paper or the like. As illustrated in FIG. 10E, a discharge port 430Ya1 (a first discharge port) is provided on a back surface 4300Ya of the first frame 430Ya.

As illustrated in FIG. 10C, a reception port 430Yb1 (a first reception port or a first intake port) is provided on a bottom surface 4300Yb of the second frame 430Yb.

The discharge port 430Ya1 and the reception port 430Yb1 may be provided on surfaces of the cartridge 430Y other than surfaces intersecting the second direction Y (surfaces of which the normal directions are the second direction Y), which is the direction in which the cartridges 430 are aligned. With this configuration, it is possible to reduce gaps G (Gym, Gmc, and Gck) between the cartridges 430 illustrated in FIG. 4A.

This results in eliminating the need for gaps for conveyance paths usable to provide a discharge port 430a1 and a reception port, and it is possible to increase the widths L of the cartridges 430. Thus, it is possible to increase the volumes for storing toner in the cartridges 430. The gap Gym is a gap in the second direction Y between the cartridges 430Y and 430M. The gap Gmc is a gap in the second direction Y between the cartridges 430M and 430C. The gap Gck is a gap in the second direction Y between the cartridges 430C and 430K.

As illustrated in FIG. 10E, the discharge port 430Ya1 is provided on the back surface 4300Ya of the cartridge 430Y (an end surface on the downstream side in the attachment direction of the cartridge 430Y) to open toward the downstream side in the attachment direction. Thus, when the cartridge 430Y is attached to the cartridge holder 429, the discharge port 430Ya1 may be readily engaged, opposed to the cartridge holder 429 in the attachment direction to communicate with the reception port 429Ya of the cartridge holder 429. The discharge port 430Ya1 may be provided on the bottom surface 4300Yb or the upper surface of the cartridge 430Y, or the reception port 430Yb1 may be provided on the back surface 4300Ya or the upper surface of the cartridge 430Y. If there is space to spare in the apparatus main body 72, the discharge port 430Ya1 and the reception port 430Yb1 may be provided on the surfaces intersecting the second direction Y, with the above description similarly applying to colors other than yellow.

The cartridge 430M includes a discharge port (a second discharge port) and a reception port (a second reception port or a second intake port) in placement similar to the cartridge 430Y. The cartridge 430C includes a discharge port 430Ca1 (a third discharge port) and a reception port (a third reception port or a third intake port) in placement similar to the cartridge 430Y. The cartridge 430K includes a discharge port 430Ka1 (a fourth discharge port) and a reception port 430Kb1 (a fourth reception port or a fourth intake port) in placement similar to the cartridge 430Y.

A sealing member (a seal or a shutter) may be provided in the discharge port 430Ya1.

In the state where the cartridge 430Y is not attached to the cartridge holder 429 of the apparatus main body 72, the sealing member seals the discharge port 430Ya1 and prevents toner T stored inside the cartridge 430Y from leaking to outside the cartridge 430Y. When the cartridge 430Y is attached to the cartridge holder 429, the sealing member is removed or moved, and the cartridge 430Y enters the state where the discharge port 430Ya1 is opened.

A label 430Ys on the front surface of the cartridge 430Y illustrated in FIG. 10A indicates the color of the toner T inside the cartridge 430Y. The label 430Ys also indicates information regarding the cartridge 430Y, such as an instruction illustrating a method for attaching the cartridge 430Y to the cartridge holder 429, and the like.

As illustrated in FIG. 11C, the first frame 430Ya and the second frame 430Yb include a flange portion 430Ya2 and a flange portion 430Yb2, respectively. The flange portions 430Ya2 and 430Yb2 are welded to each other by ultrasonic welding, whereby an internal space SPY of the cartridge 430Y illustrated in FIG. 11A is formed. The flange portions 430Ya2 and 430Yb2 illustrated in FIG. 11C may be fixed to each other with an adhesive or screws.

As illustrated in FIG. 11A, the filter 83Y is provided to partition (divide) the internal space SPY of the cartridge 430Y into two spaces, namely a toner chamber 430Yc (a first chamber) and an air chamber 430Yd (a second chamber). That is, the air chamber 430Yd is adjacent to the toner chamber 430Yc through the filter 83Y, with the above description being similarly applicable to colors other than yellow.

The filter 83M is provided to partition (divide) an internal space SPM of the cartridge 430M into two spaces, namely a toner chamber 430Mc (a third chamber) and an air chamber 430Md (a fourth chamber). That is, the air chamber 430Md is adjacent to the toner chamber 430Mc through the filter 83M. The filter is provided to partition (divide) an internal space SPC of the cartridge 430C into two spaces, namely a toner chamber (a fifth chamber) and an air chamber (a sixth chamber), which is adjacent to the toner chamber through the filter. The filter 83K is provided to partition (divide) an internal space SPK of the cartridge 430K into two spaces, namely a toner chamber (a seventh chamber) and an air chamber (an eighth chamber), which is adjacent to the toner chamber through the filter 83K.

As illustrated in FIG. 11A, the toner chamber 430Yc is located above the air chamber 430Yd and is aligned with the air chamber 430Yd in the third direction Z. That is, the orientation of the cartridge 430Y locates the toner chamber 430Yc above the air chamber 430Yd, with the cartridge 430Y attached to the apparatus main body 72. Thus, in the present embodiment, the reception port 430Yb1 opens in this direction of alignment, and the discharge port 430Ya1 opens in a direction intersecting the alignment direction.

The toner chamber 430Yc is configured to store the toner T. In the toner chamber 430Yc, the toner T is in the state where the toner T is supported by the filter 83Y.

Toner is not stored in the air chamber 430Yd. The filter 83Y is formed of, for example, a porous member composed of resin fibers, and the pores have a size and a density that allow air to pass through while preventing toner from passing through. As illustrated in FIGS. 11A to 12B, the filter 83Y is held between the first frame 430Ya and the second frame 430Yb with an outer edge portion 83Ya sandwiched between the flange portion 430Ya2 of the first frame 430Ya and the flange portion 430Yb2 of the second frame 430Yb. The filter 83Y slopes from the outer edge portion 83Ya toward a lowermost portion 83Yb below the outer edge portion 83Ya. That is, the filter 83Y includes a sloping portion formed so that, in the direction closer to the lowermost portion 83Yb in the first direction X, the second direction Y (horizontal direction) extends further downward.

The lowermost portion 83Yb protrudes relative to the outer edge portion 83Ya in a direction from the toner chamber 430Yc to the air chamber 430Yd. As illustrated in FIGS. 11A and 12B, the lowermost portion 83Yb is provided in a central portion of the filter 83Y in the first direction X and the second direction Y.

In the toner chamber 430Yc, the discharge pipe 85Y (passage) is provided. The discharge pipe 85Y according to the present embodiment is a member molded with a resin, but may be formed of paper, rubber, or the like. The discharge pipe 85Y includes an inlet 85Ya (first opening) and an outlet (second opening) and extending from the inlet 85Ya to the outlet. The discharge pipe 85Y is a passage through which the toner T stored in the toner chamber 430Yc passes when the toner T is moved toward the discharge port 430Ya1. The discharge pipe 85Y includes a first portion 85Y1 in which the inlet 85Ya is provided and which extends in the third direction Z, and a second portion 85Y2 in which the outlet 85Yb is provided and which extends in the first direction X.

The direction in which the first portion 85Y1 extends and the direction in which the second portion 85Y2 extends intersect (are orthogonal to) each other. The outlet of the discharge pipe 85Y is connected to the discharge port 430Ya1 to communicate with the discharge port 430Ya1. The inlet 85Ya of the discharge pipe 85Y is placed opposed to the lowermost portion 83Yb, which is a part of the filter 83Y, with a gap between the inlet 85Ya and the lowermost portion 83Yb. The inlet 85Ya may be close to the filter 83Y. If the remaining amount of the toner T in the toner chamber 430Yc becomes small, the toner T fluidized by the air received from the reception port 430Yb1 moves along the slope of the filter 83Y and concentrates in the lowermost portion 83Yb. The inlet 85Ya of the discharge pipe 85Y guides the toner T concentrated in the lowermost portion 83Yb of the filter 83Y to the discharge port 430Ya1. With this configuration, even as the remaining amount of the toner T stored in the toner chamber 430Yc of the cartridge 430Y is reduced, it is possible to efficiently discharge the toner T to outside the cartridge 430Y.

A cartridge according to the present embodiment has a structure where toner is discharged to outside the cartridge by air, and a rotary member such as a screw or the like does not need to be provided. Thus, it is possible to achieve a cartridge having a simple structure where the number of components is small.

### Toner Conveyance Mechanism

A description is given of a mechanism for conveying the toner T stored in the toner chamber 430Yc of the cartridge 430Y to the development unit 9Y.

As illustrated in FIG. 7A, the air is discharged upward from the discharge outlet 80Ya of the pump unit 80Y. As illustrated in FIG. 11A, the air is received by the air chamber 430Yd through the reception port 430Yb1 of the cartridge 430Y. Then, the air passes through the filter 83Y while increasing the atmospheric pressure of the air chamber 430Yd, and flows into the toner chamber 430Yc. The air flowing into the toner chamber 430Yc enters between particles of the toner T and fluidizes the toner T. The toner T fluidized by being mixed with the air is moved in the discharge pipe 85Y from the inlet 85Ya to the outlet by the air through the reception port 430Yb1.

Then, the toner T is discharged from the discharge port 430Ya1 to outside the cartridge 430Y.

As in the present embodiment, as illustrated in FIG. 11A, the air chamber 430Yd that is an airtight space is provided between the discharge outlet 80Ya and the filter 83Y illustrated in FIG. 7A, whereby the air discharged from the discharge outlet 80Ya efficiently travels toward the filter 83Y without being dispersed to outside the cartridge 430Y. For example, in a situation where the toner T in the toner chamber 430Yc is likely to clump, such as a situation where the cartridge 430Y receives a vibration or is left for a long time, the pressure required to cause the air to pass through the filter 83Y and flow into the toner chamber 430Yc is high. Even in such a case, the air continues to be sent from the pump unit 80Y illustrated in FIG. 7A to the air chamber 430Yd illustrated in FIG. 11A, thereby raising the pressure (the atmospheric pressure) in the air chamber 430Yd. In this manner, the air can be sent into the toner chamber 430Yc by passing through the filter 83Y.

The air chamber 430Yd is provided, whereby the pump unit 80Y can continue to send the air into the air chamber 430Yd without dispersing the air until the pressure in the air chamber 430Yd reaches the pressure required to cause the air to pass through the filter 83Y into the toner chamber 430Yc. The pump unit 80Y only needs to have the ability to generate such pressure, and the discharge speed and the discharge amount are not particularly requested. Thus, it is also possible to configure the pump unit 80Y using a small-sized pump unit and contribute to miniaturizing the apparatus.

As illustrated in FIG. 4B, the toner T discharged from the discharge port 430Ya1 of the cartridge 430Y enters inside the replenishment pipe 444Y from the upstream end portion 444Yu (as illustrated in FIG. 7A) through the reception port 429Ya of the cartridge holder 429. The toner T entering the replenishment pipe 444Y from the upstream end portion 444Yu is moved to the downstream end portion 444Yd by the air that flows in with the toner T, and is replenished to the development unit 9Y (the development container 3Y) of the process unit PY.

As illustrated in FIG. 6B, the toner T is replenished into the development unit 9Y (the development container 3Y) from an end portion in the second direction Y of the development unit 9Y. The toner T is agitated and leveled in the development container 3Y by agitation members SY1 and SY2, illustrated in FIG. 7B. Each of the agitation members SY1 and SY2 may be a screw configured to convey the toner T from an end portion of the development unit 9Y on the side where the downstream end portion 444Yd of the replenishment pipe 444Y is connected to an end portion of the development unit 9Y on the opposite side in the second direction Y.

A space in the development unit 9Y (the development container 3Y) to which yellow toner is replenished may be referred to as a first space. A space in the development unit 9C (the development container 3C) to which cyan toner is replenished may be referred to as a second space. A space in the development unit 9M (the development container 3M) to which magenta toner is replenished may be referred to as a third space. A space in the development unit 9K (the development container 3K) to which black toner is replenished may be referred to as a fourth space.

Since not only the toner T but also the air flows into the development unit 9Y (the development container 3Y) from the replenishment pipe 444Y, the internal pressure in the development unit 9Y is likely to rise. Accordingly, in the present embodiment, as illustrated in FIGS. 4A, 4B, and 6B, an air exhaust filter PYf is provided on the upper surface of the development unit 9Y. The air exhaust filter portion PYf is a portion where a through-hole is provided in a frame forming the development unit 9Y, and a filter such as a non-woven fabric or the like is provided in the through-hole. The filter is configured to allow the air to pass therethrough while preventing the toner T from passing therethrough. The toner T flowing into the development unit 9Y from the replenishment pipe 444Y remains in the development unit 9Y. At least a part of the air is discharged from the air exhaust filter portion PYf to outside the development unit 9Y. This prevents a rise in the internal pressure inside the development unit 9Y, and the toner T and the air are likely to flow into the development unit 9Y from the cartridge 430Y through the replenishment pipe 444Y.

In the present embodiment, the air exhaust filter PYf is provided in a central portion of the development unit 9Y in the second direction Y. The air exhaust filter PYf may be provided at a position indicated as an air exhaust filter PYfa. In this case, the air exhaust filter PYfa is located in an end portion of the development container 3Y on the side where the upstream end portion 444Yu of the replenishment pipe 444Y is located in the second direction Y. Alternatively, as indicated as an air exhaust filter PYfb, the air exhaust filter PYf may be provided in an end portion of the development unit 9Y on the opposite side of the end portion on the side where the upstream end portion 444Yu of the replenishment pipe 444Y is located in the second direction Y. The air exhaust filter PYf may be provided not on the upper surface but on a side surface of the development unit 9Y.

In the case of a configuration in which the direction of a conveyance path changes in the middle or a configuration in which a conveyance path differs depending on the color as in the replenishment pipes 444 according to the present embodiment, air may be employed as a conveyance method for conveying toner. The degree of freedom in designing a conveyance path improves as compared to the employment of a screw or the like as a conveyance method. Since a conveyance member is unnecessary, it is possible to reduce the number of components.

Although a conveyance method using air has been described in this configuration, a conveyance method such as a screw or the like may be used. Alternatively, conveyance methods using air and a screw may be used in combination.

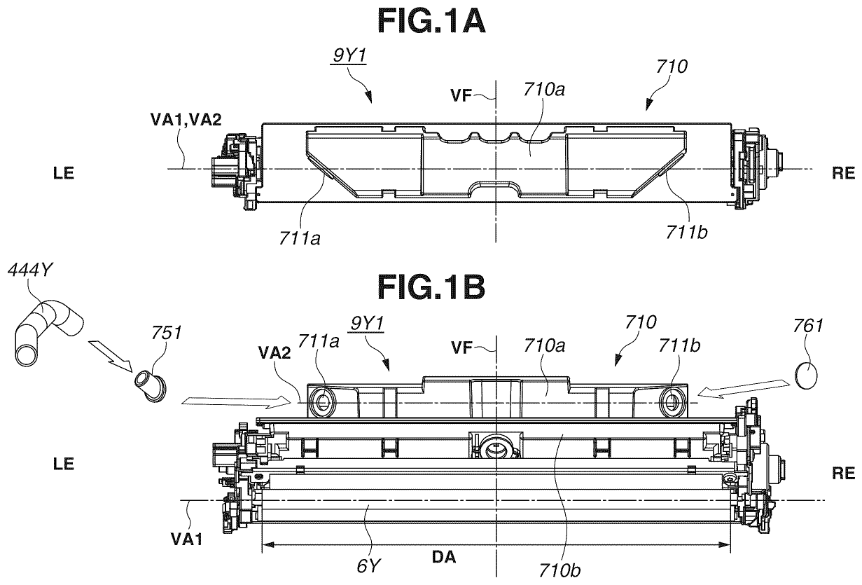

With reference to FIGS. 1A and 1B and FIGS. 13A and 13B to FIG. 21, characteristic portions according to the first embodiment of the present disclosure are described.

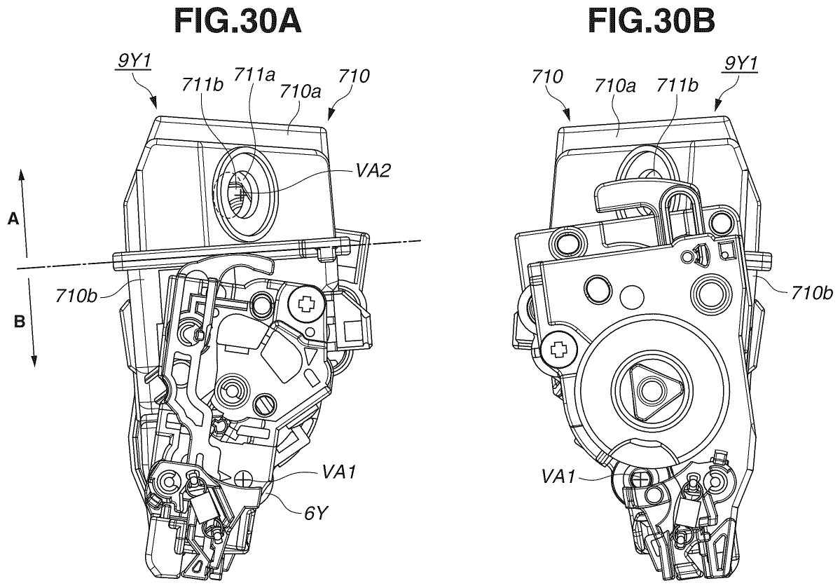

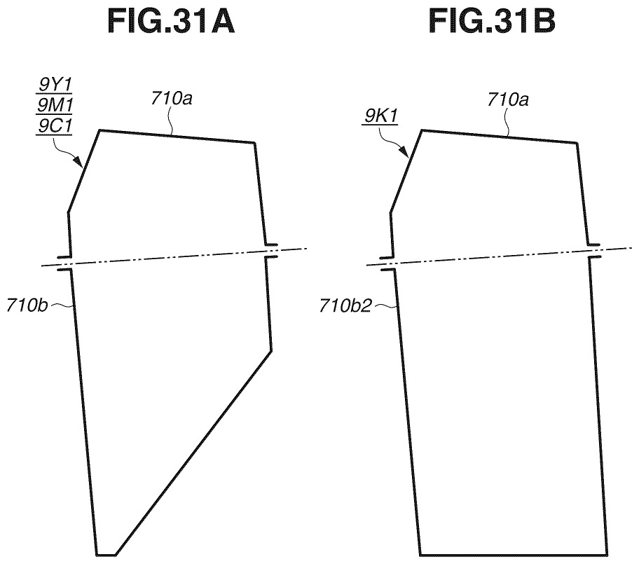

FIG. 1A illustrates a top view of a development unit 9Y1. FIG. 1B illustrates a front view of the development unit 9Y1. FIG. 1B illustrates an assembly diagram with components to be assembled to the development unit 9Y1. FIGS. 30A and 30B illustrate side views of the development unit 9Y1. FIG. 30A provides a view from the LE side of FIGS. 1A and 1B. FIG. 30B provides a view from the RE side of FIGS. 1A and 1B. FIGS. 31A and 31B illustrate schematic side views of the development unit 9. FIGS. 31A and 31B are each view from the LE side. FIG. 31B is a side view of the development unit 9K1 for black. FIG. 31A is a side view of the development unit (9Y1, 9M1, 9C1) for each of the colors other than black.

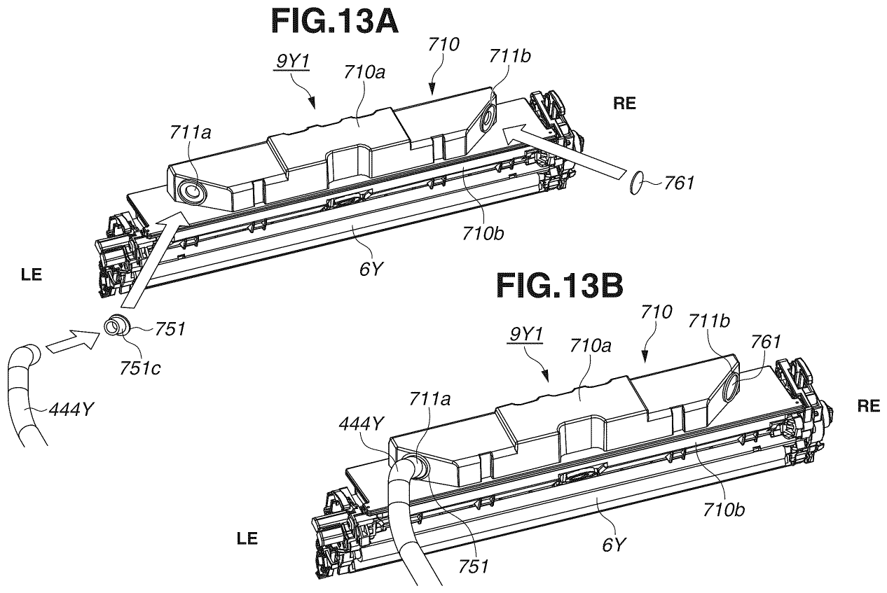

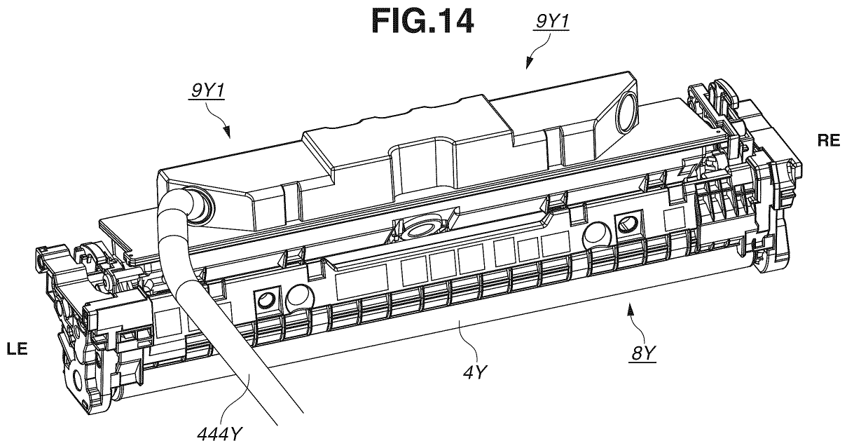

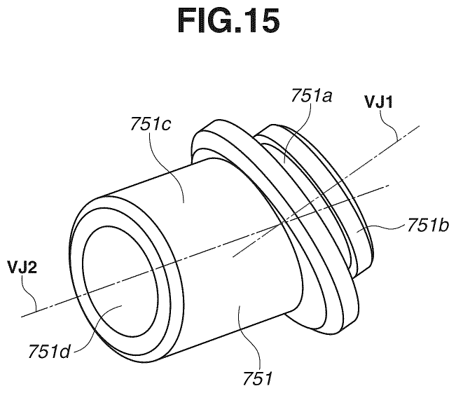

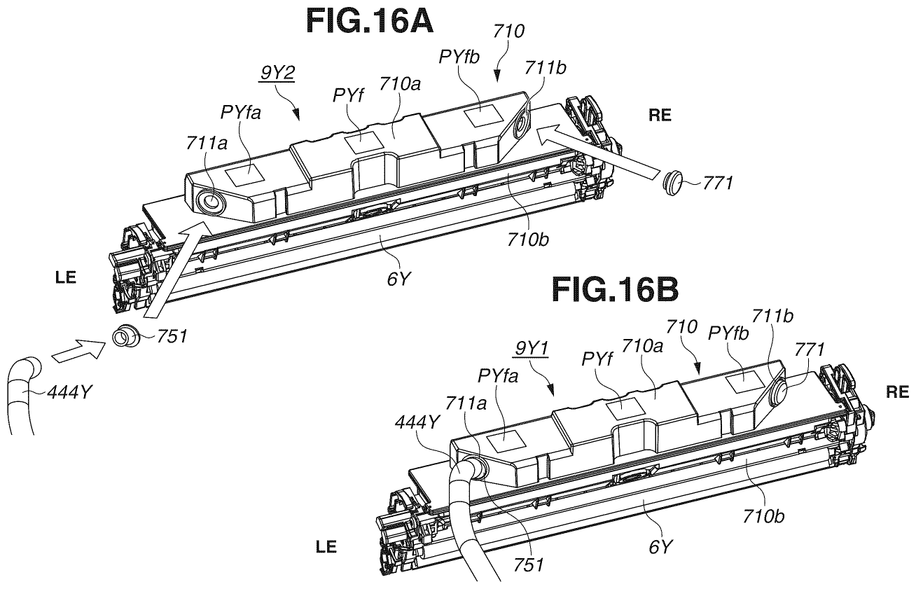

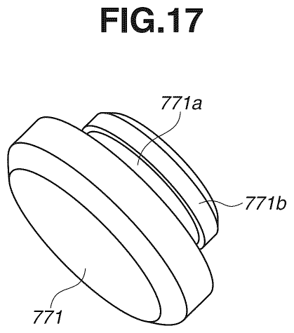

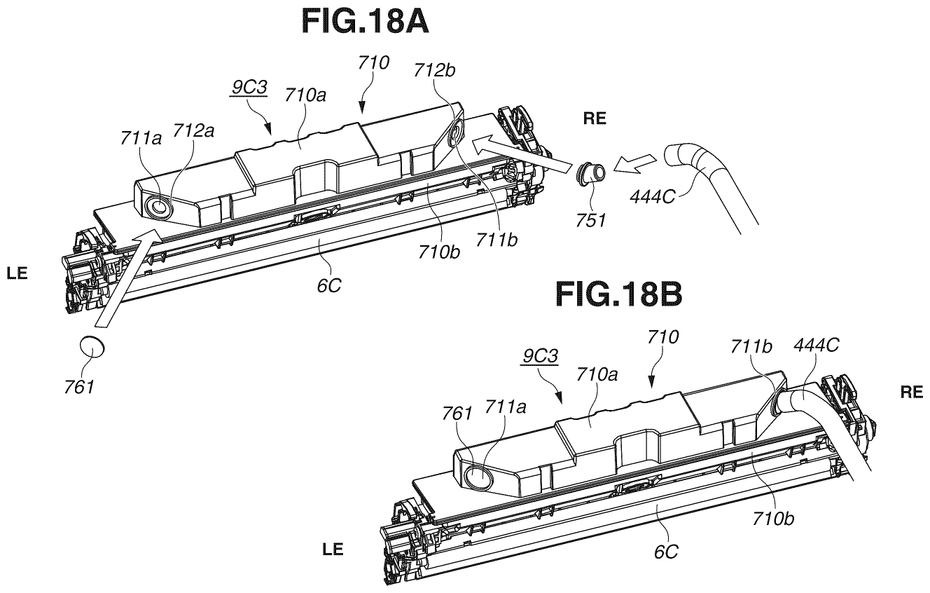

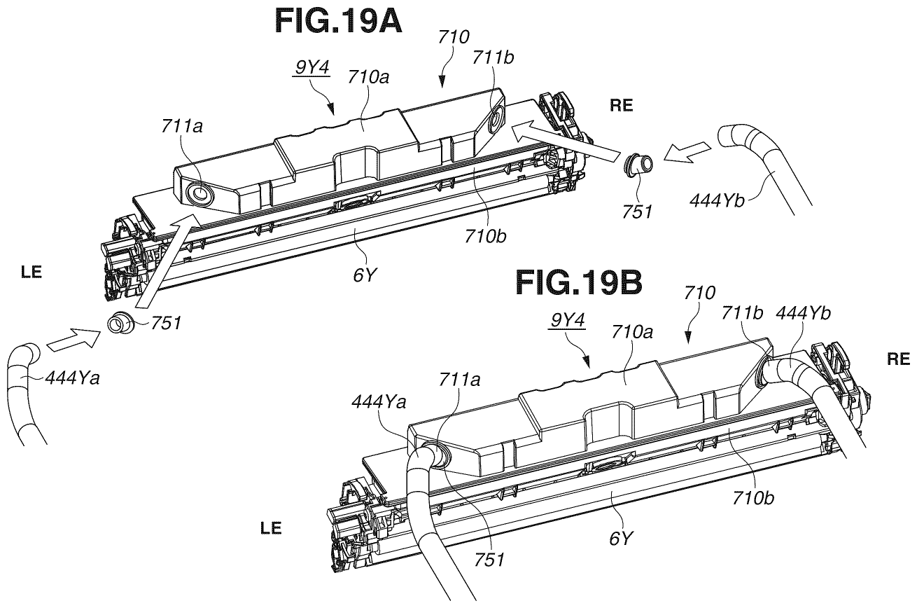

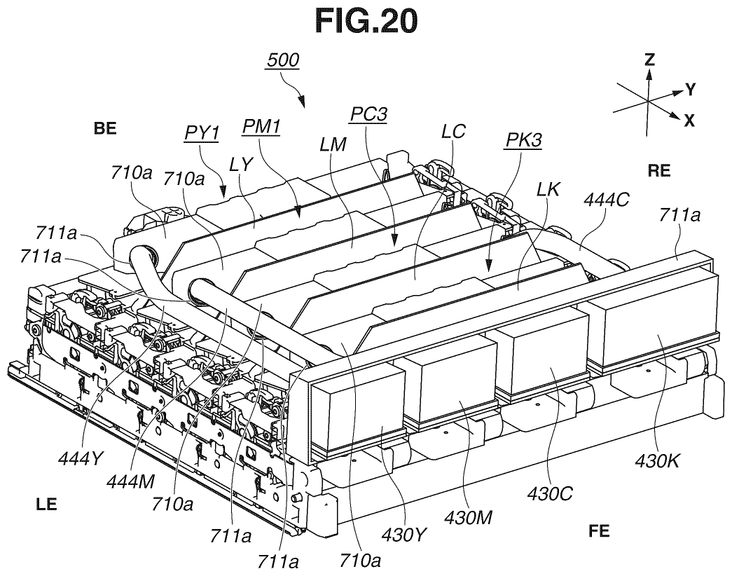

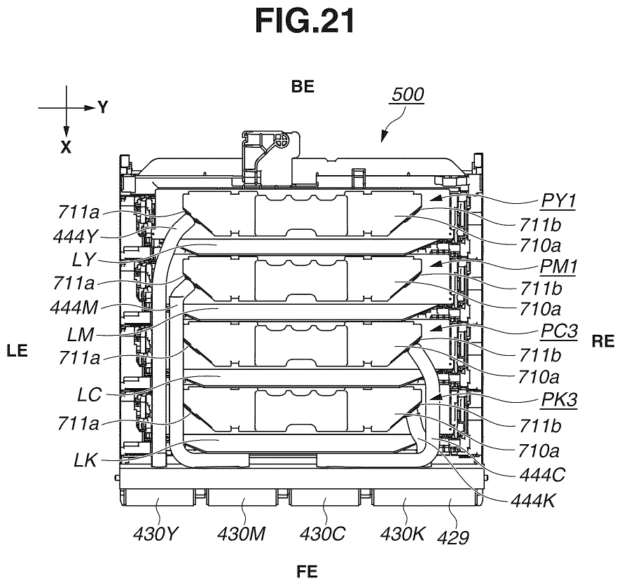

FIG. 13A is a perspective view of the assembly of the development unit 9Y1. FIG. 13B is a perspective view after the assembly of the development unit 9Y1 is completed. FIG. 14 is a perspective view of a process cartridge PY1. FIG. 15 is a perspective view of a relay member 751. FIG. 16A is a perspective view of the assembly of a development unit 9Y2. FIG. 16B is a perspective view after the assembly of the development unit 9Y2 is completed. FIG. 17 is a perspective view of a sealing cap 771. FIG. 18A is a perspective view of the assembly of a development unit 9C3. FIG. 18B is a perspective view after the assembly of the development unit 9C3 is completed. FIG. 19A is a perspective view of the assembly of a development unit 9Y4. FIG. 19B is a perspective view after the assembly of the development unit 9Y4 is completed. FIG. 20 is a perspective view of the image forming unit 500, illustrating the laser optical paths (LY, LM, LC, and LK). FIG. 21 is a top view of the image forming unit 500, illustrating the laser optical paths (LY, LM, LC, and LK).

### Holes on Cover

A development unit 9Y1 illustrated in FIGS. 1A and 1B includes improvements to the development unit 9Y. As illustrated in FIG. 1B, the development unit 9Y1 includes a toner storage container 710 to which toner is supplied from a toner cartridge that is a toner replenishment container through the replenishment pipe 444Y that is a toner supply pipe. The toner storage container 710 includes a toner container 710b that rotatably supports the development roller 6Y, and a cover 710a that closes an opening of the toner container 710b. The cover 710a is welded and joined to the opening of the toner container 710b.

The cover 710a includes a first hole 711a and a second hole 711b that are through-holes at different positions on the rotational axis direction of a virtual axis VA2 parallel to a rotating shaft VA1 of the development roller 6Y.

The shapes of first hole 711a and the second hole 711b are the same. The first hole 711a and the second hole 711b are symmetrically positioned with respect to a longitudinal center VF of a toner bearing region DA of the development roller 6Y.

In FIGS. 1A and 1B, the first hole 711a is placed on the non-driving side LE, and the second hole 711b is placed on the driving side RE.

FIGS. 30A and 30B are diagrams illustrating side views of the development unit 9Y1, viewed in the rotational axis direction of the rotating shaft VA1 of the development roller 6Y. When viewed in the rotational axis direction of the rotating shaft VA1 of the development roller 6Y in this manner, the first hole 711a and the second hole 711b are located at overlapping positions. Although in FIG. 30A, an ellipse indicating the position of the first hole 711a and an ellipse indicating the position of the second hole 711b do not match each other, the positions of the two holes may be configured to match each other.

The toner storage container 710 is configured by dividing the toner storage container 710 into the toner container 710b and the cover 710a along the position of a virtual line in FIG. 30A. An arrow A side corresponds to the cover 710 a, and an arrow B side corresponds to the toner container 710b.

The cover 710a may be common to yellow, cyan, magenta, and black, and the volume of only a toner container for black may be increased. FIG. 31A illustrates the configuration of yellow, cyan, or magenta. FIG. 31B illustrates the configuration of black. As illustrated in FIGS. 31A and 31B, the volume of a toner container 710b2 for black is greater than that of a toner container 710b for each of the other colors. However, the cover 710a is common to all the colors. As described above, even if the storage amount of a toner container is changed according to the toner color, the cover 710a is common, making it is possible to similarly obtain effects according to the present embodiment.

### Relay Member

A description is given of the relay member 751 (a first relay member) linking the replenishment pipe 444Y and the toner storage container 710 illustrated in FIG. 1B. As illustrated in FIG. 15, the relay member 751 is formed of an elastic member. The relay member 751 includes a container attachment portion 751b having a cylindrical groove 751a and is assembled to the first hole 711a (FIG. 13A) by fitting the first hole 711a. The relay member 751 also includes a cylindrical pipe attachment portion 751c to which the replenishment pipe 444Y is attached. The relay member 751 includes a through-hole 751d as a conveyance passage for toner inside.

As illustrated in FIG. 13A, the relay member 751 is assembled to the first hole 711a. The outer diameter of the cylindrical groove 751a of the relay member 751 in FIG. 15 is set to be greater than the inner diameter of the first hole 711a in FIG. 13A. The container attachment portion 751b is elastically deformed to be assembled to the first hole 711a. As a result, the relay member 751 fills the gap between contact portions of the components and prevents the leakage of toner from the toner storage container 710 to outside.

Examples of another assembling method include adhesion that enables the sealing of toner in the contact portions of the components.

In contrast, the use of the relay member 751 of an elastic body eliminates the need for adhesion.

A method for using a seal member that fills the gap between the relay member 751 and the toner storage container 710 is also possible.

The outer diameter of the pipe attachment portion 751c is set to be greater than the inner diameter of the replenishment pipe 444Y. The pipe attachment portion 751c is configured to be elastically deformable, and therefore is assembled to the replenishment pipe 444Y while contracting according to the inner diameter of the replenishment pipe 444Y. As a result, the relay member 751 fills the gap between assembling portions (the outer diameter and the inner diameter) of the components and prevents the leakage of toner from the portion to which the replenishment pipe 444Y is attached to outside. Even if the relay member 751 is a non-elastic body, but if the replenishment pipe 444Y is an elastic body, it is possible to obtain similar effects.

As illustrated in FIG. 15, the relay member 751 is formed so that a central axis VJ2 of the pipe attachment portion 751c is not coaxial with a central axis VJ1 of the container attachment portion 751b, and crosses the central axis VJ1 of the container attachment portion 751b at a predetermined angle. After the container attachment portion 751b is attached to the first hole 711a of the development unit 9Y1, the relay member 751 is rotated about the central axis VJ1, whereby it is possible to change the angle of protrusion of the pipe attachment portion 751c from the container. As described above, it is possible to adjust the angle of protrusion with a single type of relay member 751. Thus, it is possible to provide flexibility to the placement of the replenishment pipe 444Y.

### Air Exhaust Filter

As illustrated in FIG. 13A, an air exhaust filter 761 is attached to the second hole 711b by a method such as welding, adhesion, or the like. As described above, the toner T flowing into the development unit 9Y1 from the replenishment pipe 444Y remains in the development unit 9Y1, and at least a part of the air is discharged from the air exhaust filter 761 to outside the development unit 9Y1. This prevents a rise in the internal pressure inside the development unit 9Y1, and the toner T and the air are likely to flow into the development unit 9Y1 from the cartridge 430Y through the replenishment pipe 444Y.

FIG. 13B illustrates the state where the relay member 751, the replenishment pipe 444Y, and the air exhaust filter 761 are assembled to the development unit 9Y1. Then, the development unit 9Y1 is assembled to the drum unit 8Y, and a process cartridge PY1 is completed (FIG. 14).

### Sealing Cap

As illustrated in FIGS. 16A and 16B, if the air exhaust filters PYf, PYfa, and PYfb are placed on the upper surface of the cover 710a, air can be sufficiently exhausted, and therefore the air exhaust filter 761 does not need to be further placed in the second hole 711b. In this case, a sealing cap 771 that seals toner in the toner storage container 710 can also be assembled to the second hole 711b. The sealing cap 771 is formed of an elastic member into a shape as illustrated in FIG. 17. The sealing cap 771 includes a container attachment portion 771b having a cylindrical groove 771a and is assembled to the second hole 711b (FIG. 16A) by fitting the second hole 711b. The outer diameter of the cylindrical groove 771a of the sealing cap 771 is set to be greater than the inner diameter of the second hole 711b. Consequently, the container attachment portion 771b is assembled to the second hole 711b while elastically deforming and contracting. As a result, the sealing cap 771 fills the gap between contact portions of the components and prevents the leakage of toner from the toner storage container 710 to outside.

### Reverse Placement of Relay Member

As illustrated in FIGS. 20 and 21, the replenishment pipes 444 for the respective colors are dispersedly placed on the non-driving side LE and the driving side RE (two replenishment pipes 444 are dispersedly placed on each of the non-driving side LE and the driving side RE in FIGS. 20 and 21), and space in the main body 72 is effectively used. That is, in this case, the configuration of a development unit in which the placement of the development unit 9Y1 and the replenishment pipes 444Y is reversed in the longitudinal direction of the development roller 6 is required.

In this case, as illustrated in FIG. 18A, the shapes of the first hole 711a and the second hole 711b are the same. Thus, the relay member 751 is assembled to the second hole 711b. Consequently, the replenishment pipe 444C can be assembled to the relay member 751. Further, the air exhaust filter 761 can be assembled to the first hole 711a.

Circular ribs 712a and circular ribs 712b having the same shape are formed around the first hole 711a and the second hole 711b on the cover 710a. The ribs 712a and 712b can also be used to position the circular air exhaust filter 761.

Instead of the air exhaust filter 761, the sealing cap 771 can also be provided.

### Placement of Relay Members at Both Ends

As illustrated in FIGS. 19A and 19B, a replenishment pipe 444Ya can also be placed on the non-driving side LE, and a replenishment pipe 444Yb can also be placed on the driving side RE, respectively. This can increase the replenishment speed. Toner is replenished from both ends, whereby toner in the toner storage container 710 is easily mixed.

Descriptions have been provided above of the development units 9Y1, 9Y2, and 9Y4 that store yellow (Y) toner and the development unit 9C3 that stores cyan (C) toner. The configurations of these development units are also similarly applicable to any of development units that store yellow (Y), magenta (M), cyan (C), and black (K) toner.

As illustrated in FIG. 1B, the cover 710a includes the first hole 711a and the second hole 711b at different positions on the virtual axis VA2 parallel to the rotating shaft VA1 of the development roller 6Y. The shapes of these holes are the same. Consequently, as illustrated in FIGS. 13A and 13B and FIGS. 16A and 16B, the relay members 751, the air exhaust filter 761, and the sealing cap 771 may be selectively placed in the first hole 711a and the second hole 711b without increasing exclusive components with respect to each color on the cover 710a.

Even if the shapes of the first hole 711a and the second hole 711b are different from each other, attachment portions of the relay members 751, the air exhaust filter 761, and the sealing cap 771 to be attached to the holes are configured to be able to correspond to the different shapes of these plurality of holes. Consequently, it is possible to selectively place the relay members 751, the air exhaust filter 761, and the sealing cap 771. If, however, the shapes of the holes are the same, it is possible to simplify the shapes of the attachment portions of the relay members 751, the air exhaust filter 761, and the sealing cap 771 more.

The first hole 711a and the second hole 711b are placed symmetrically with respect to the longitudinal center VF of the toner bearing region DA of the development roller 6Y. In this manner, it is possible to place the replenishment pipes 444 in short distances at both longitudinal ends by avoiding the laser optical paths L located in the longitudinal centers. As a result, it is possible to optimally replenish toner to the development units 9 while miniaturizing the main body 72.

With this configuration, it is possible to configure the cover 710a as a common component having the same shape among the toner colors. This decreases the types of components at the time of assembly at the factory and facilitates management, thereby reducing costs. If the cover 710a is a resin injection molding product, since the cover 710a has a shape common to the toner colors, a common metal mold can be utilized.

Consequently, a metal mold corresponding to only a single color is required, and therefore, the metal mold can be obtained at low cost according to a decrease in the number of molds. Since the cover 710a is a common component, the component dimensions for the respective colors also match each other. If a single metal mold is used, the dimensions do not vary due to the metal mold. Interfaces with the relay member 751, the air exhaust filter 761, the sealing cap 771, and the like are also common, and therefore, it is possible to enjoy advantage that include, for example, improved manage dimensions of interface portions.

### Second Embodiment

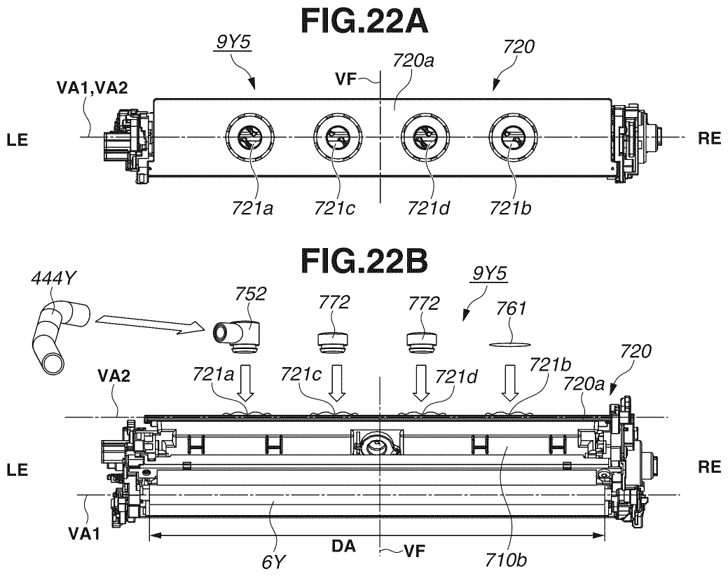

With reference to FIG. 22A to FIG. 26, characteristic portions according to a second embodiment of the present disclosure are described.

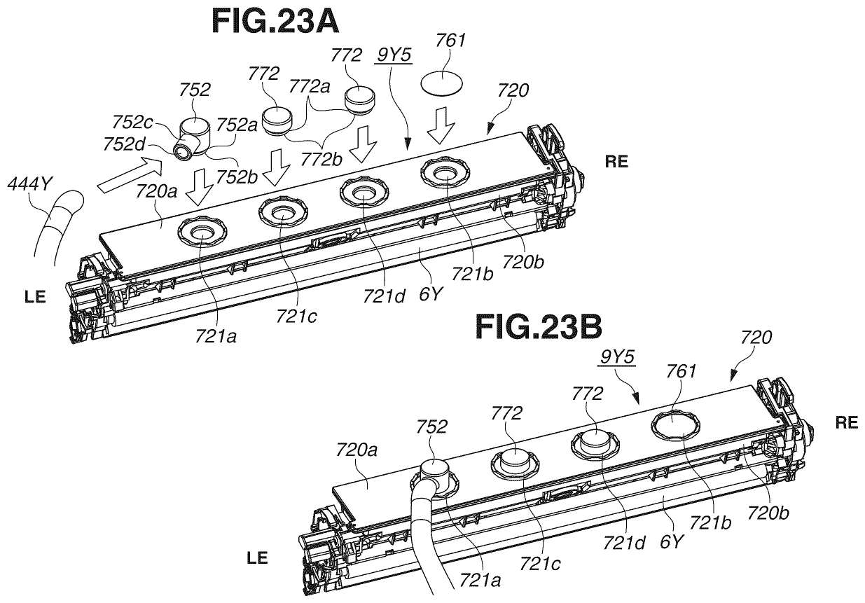

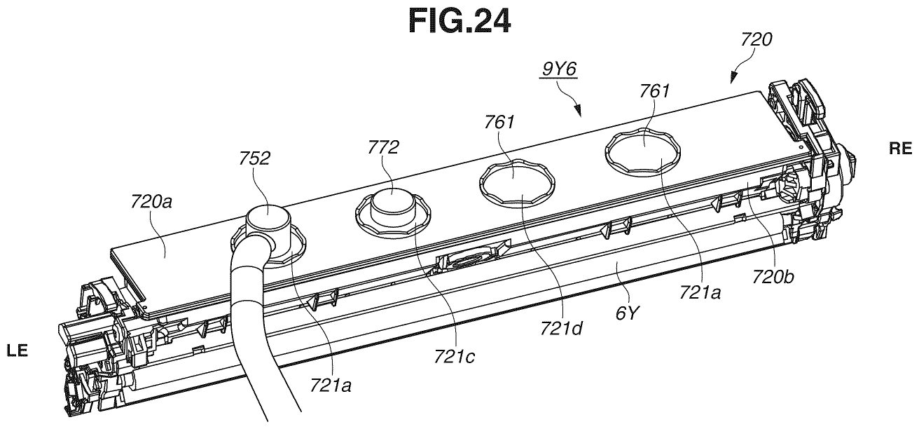

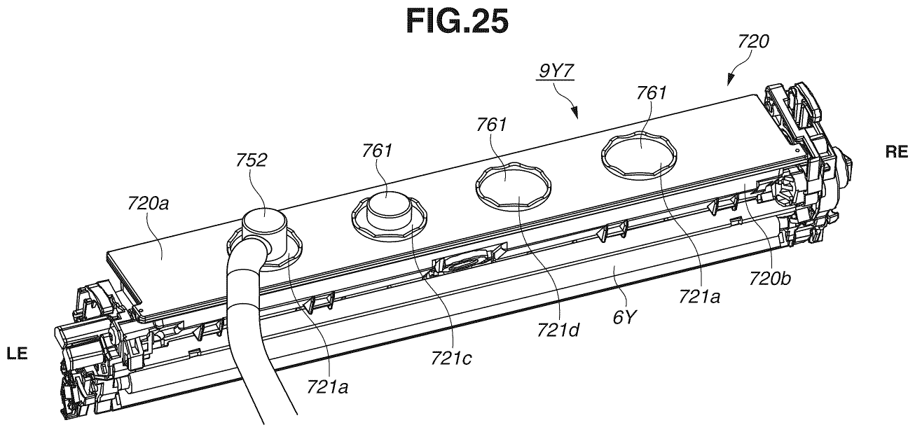

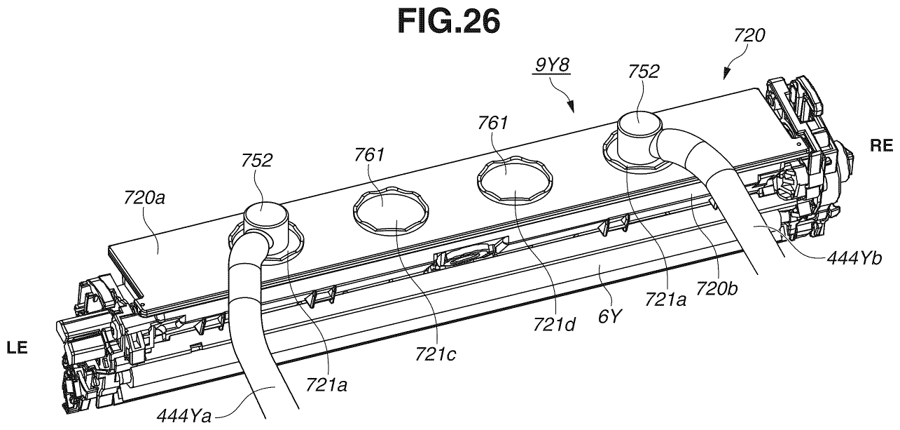

FIG. 22A illustrates a top view of a development unit 9Y5. FIG. 22B illustrates a front view of the development unit 9Y5. FIG. 22B doubles as an assembly diagram illustrating components to be assembled to the development unit 9Y5. FIG. 23A is a perspective view of the assembly of the development unit 9Y5. FIG. 23B is a perspective view after the assembly of the development unit 9Y5 is completed. FIG. 24 is a perspective view after the assembly of a development unit 9Y6 is completed. FIG. 25 is a perspective view after the assembly of a development unit 9Y7 is completed. FIG. 26 is a perspective view after the assembly of a development unit 9Y8 is completed.

### Holes on Cover

As illustrated in FIG. 22B, a development unit 9Y5 includes a toner storage container 720 to which toner is supplied from a toner cartridge that is a toner replenishment container through the replenishment pipe 444Y that is a toner supply pipe. The toner storage container 720 includes a toner container 720b that rotatably supports the development roller 6Y, and a cover 720a that closes an opening of the toner container 720b (FIGS. 23A and 23B). The cover 720a is welded and joined to the opening of the toner container 720b.

As illustrated in FIG. 22B, the cover 720a includes a first hole 721a, a second hole 721b, a third hole 721c, and a fourth hole 721d that are through-holes at different positions on the virtual axis VA2 parallel to the rotating shaft VA1 of the development roller 6Y. The shapes of these holes are the same. The first hole 721a and the second hole 721b are placed symmetrically with respect to the longitudinal center VF of the toner bearing region DA of the development roller 6Y, and the third hole 721c and the fourth hole 721d are placed symmetrically with respect to the longitudinal center VF of the toner bearing region DA of the development roller 6Y.

In FIGS. 22A and 22B, the first hole 721a and the third hole 721c are placed on the non-driving side LE, and the second hole 721b and the fourth hole 721d are placed on the driving side RE.

### Relay Member

A description is given of a relay member 752 linking the replenishment pipe 444Y and the toner storage container 720. The relay member 752 illustrated in FIG. 23A is formed of an elastic member. Similar to the relay member 751 in FIG. 15, the relay member 752 includes a container attachment portion 752b having a cylindrical groove 752a. The relay member 752 is assembled to the first hole 721a of the cover 720a by fitting the first hole 721a. The relay member 752 also includes a cylindrical pipe attachment portion 752c to which the replenishment pipe 444Y is attached. The relay member 752 includes a through-hole 752d as a conveyance passage for toner inside. These components of the relay member 752 are similar to those of the relay member 751 in FIG. 15, and the description is incorporated herein by reference. The outer diameter of the cylindrical groove 752a of the relay member 752 is set to be greater than the inner diameter of the hole 721a. Consequently, the container attachment portion 752b is assembled to the first hole 721a while elastically deforming. As a result, the relay member 752 can fill the gap between contact portions of the components and prevents the leakage of toner from the toner storage container 720 to outside. Another assembling method is as described above.

Next, the replenishment pipe 444Y is attached to the pipe attachment portion 752c of the relay member 752. The outer diameter of the pipe attachment portion 752c is set to be greater than the inner diameter of the replenishment pipe 444Y. The pipe attachment portion 752c is configured to be elastically deformable, and therefore is assembled to the replenishment pipe 444Y while contracting according to the inner diameter of the replenishment pipe 444Y. As a result, the relay member 752 fills the gap between portions (the outer diameter and the inner diameter) to which the components are assembled and prevents the leakage of toner from these portions to outside. In a case where the relay member 752 is formed of a non-elastic body, and if the replenishment pipe 444Y is an elastic body, it is possible to obtain similar effects.

### Air Exhaust Filter

The air exhaust filter 761 is attached to the second hole 721b by a method such as welding, adhesion, or the like to the cover 720a. Consequently, the toner T and the air are likely to flow into the development unit 9Y5 from the cartridge 430Y through the replenishment pipe 444Y (similar to the effects of the above air exhaust filter 761).

### Sealing Caps

As illustrated in FIG. 23A, sealing caps 772 that seal toner in the toner storage container 720 are assembled to the third hole 721c and the fourth hole 721d.

The sealing caps 772 are each formed of an elastic member. The sealing caps 772 each include a container attachment portion 772b having a cylindrical groove 772a and are assembled to the third hole 721c and the fourth hole 721d by fitting the third hole 721c and the fourth hole 721d.

The outer diameters of the cylindrical grooves 772a of the sealing caps 772 are set to be greater than the inner diameters of the third hole 721c and the fourth hole 721d. Consequently, the container attachment portions 772b are assembled to the third hole 721c and the fourth hole 721d while elastically deforming. As a result, the sealing caps 772 each fill the gap between contact portions of the components and prevent the leakage of toner from the toner storage container 720 to outside.

FIG. 23B illustrates the state where the relay member 752, the replenishment pipe 444Y, the air exhaust filter 761, and the sealing caps 772 are assembled to the development unit 9Y5. Then, the development unit 9Y5 is assembled to the drum unit 8Y, and a process cartridge is completed.

In FIG. 23B, in the longitudinal direction of the development roller 6Y, the air exhaust filter 761 is placed in the second hole 721b that is the furthest from the first hole 721a in which the relay member 752 and the replenishment pipe 444Y are placed. In the longitudinal direction, a toner replenishment port and an air discharge port are placed away from each other. As a result, the flow of air occurs in the longitudinal direction in the toner storage container 720, and therefore, toner is circulated over the longitudinal direction in the toner storage container 720.

### Addition of Air Exhaust Filter

The area of an air exhaust filter may be further expanded, depending on the degree of ventilation. In such a case, as illustrated in FIG. 24, a configuration can be employed in which an air exhaust filter 761 is also assembled to the fourth hole 721d.

Further, as illustrated in FIG. 25, a configuration can also be employed in which an air exhaust filter 761 is also further assembled to the third hole 721c.

### Placement of Relay Members at Both Ends

As illustrated in FIG. 26, the replenishment pipe 444Ya can also be placed on the non-driving side LE of a development unit 9Y8, and the replenishment pipe 444Yb can also be placed on the driving side RE. The provision of two replenishment pipes can increase the toner replenishment speed. Toner is replenished from both ends of the development unit 9Y8, whereby toner in the toner storage container 720 is easily mixed.

### Attachment Portion for Relay Member

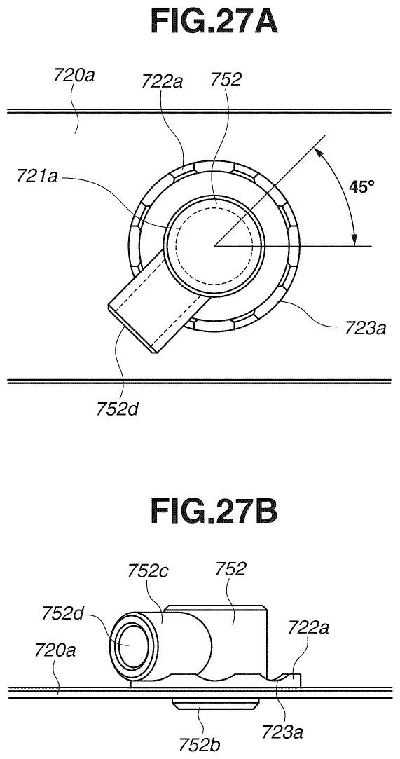

FIG. 27A is a top view illustrating the relay member 752 and a portion to which the relay member 752 is attached. FIG. 27B is a front view of FIG. 27A.

Surrounding the first hole 721a (FIG. 27A) on the cover 720a, circular ribs 722a are formed in a protruding manner. With the ribs 722a, eight recessed portions 723a are provided at 45° intervals about the center of the first hole 721 a.

As illustrated in FIGS. 23A and 23B, if the relay member 752 is attached to the first hole 721a, then as illustrated in FIG. 27B, the outer shape of the cylindrical pipe attachment portion 752c is engaged with the recessed portions 723a, and it is possible to restrict the direction that the through-hole 752d of the relay member 752 faces. In this configuration, it is possible to restrict the direction by selecting eight directions at 45° intervals when viewed from the direction in FIG. 27A. That is, it is possible to restrict the direction of the replenishment pipe 444Y connected to the development unit 9Y5 relative to the cover 720a. The direction is determined, whereby it is also possible to reduce the distance from the toner cartridge to the replenishment pipe 444Y. It is also possible to place components taking into account the flexure of the replenishment pipe 444Y, which is an elastic body. As a result of the optimal placement of the components, the conveyance of toner is excellently maintained.

The ribs 722a that are circular when viewed from above can also be used to position the circular air exhaust filter 761 when the circular air exhaust filter 761 is assembled to the cover 720a.

Relay members 752 can also be selectively attached to the second hole 721b, the third hole 721c, and the fourth hole 721d other than the first hole 721a. Surrounding these holes, shapes similar to those of the circular ribs 722a are formed. If the relay members 752 are assembled to the second hole 721b, the third hole 721c, or the fourth hole 721d, it is possible to obtain effects similar to the above.

As illustrated in FIG. 22B, the cover 720a includes the first hole 721a, the second hole 721b, the third hole 721c, and the fourth hole 721d at different positions on the virtual axis VA2 parallel to the rotating shaft VA1 of the development roller 6Y. The shapes of these holes are the same.

Consequently, it is possible to selectively place the relay members 752, the air exhaust filters 761, and the sealing caps 772 in the first hole 721a, the second hole 721b, the third hole 721c, and the fourth hole 721d without increasing exclusive components with respect to each color on the cover 720a. Holes with which a replenishment pipe 444 can be configured to be short may be selected with respect to each color. For example, the relay member 752 is placed on the first hole 721a for yellow, whereas the relay member 752 is placed on the third hole 721c for magenta. The relay member 752 is placed on the fourth hole 721d for cyan, and the relay member 752 is placed on the second hole 721b for black.

The air exhaust filter 761 is placed in a hole in an end portion on the opposite side of the side where the relay member 752 is placed in the longitudinal direction. That is, as illustrated in FIGS. 23A and 23B, the air exhaust filter 761 is placed on the second hole 721b for yellow. Similarly, the air exhaust filter 761 is placed on the second hole 721b also for magenta. The air exhaust filter 761 is placed on the first hole 721a for each of cyan and black. On each of holes in which neither the relay member 752 nor the air exhaust filter 761 is placed, the sealing cap 772 is placed.

Suppose that the shapes of the first hole 721a, the second hole 721b, the third hole 721c, and the fourth hole 721d are different from each other. Even in such a case, attachment portions of the relay members 752, the air exhaust filters 761, and the sealing caps 772 to be attached to the holes are configured to be able to correspond to the different shapes of these plurality of holes. Consequently, it is possible to selectively place the relay members 752, the air exhaust filters 761, and the sealing caps 772. If, however, the shapes of the holes are the same, it is possible to simplify the shapes of the attachment portions of the relay members 752, the air exhaust filters 761, and the sealing caps 772 more.

The first hole 711a and the second hole 711b are placed symmetrically with respect to the longitudinal center VF of the toner bearing region DA of the development roller 6Y. The third hole 721c and the fourth hole 721d are placed symmetrically with respect to the longitudinal center VF of the toner bearing region DA of the development roller 6Y. Consequently, two replenishment pipes 444 may be placed at each of both longitudinal ends, and the replenishment pipes 444 may be configured to avoid the laser optical paths L located in the longitudinal centers. Therefore, it is possible to shorten the length of each of the replenishment pipes 444 and shorten the distance at which toner is conveyed.

As a result, it is possible to optimally replenish toner to the development units 9 while miniaturizing the main body 72.

### Third Embodiment

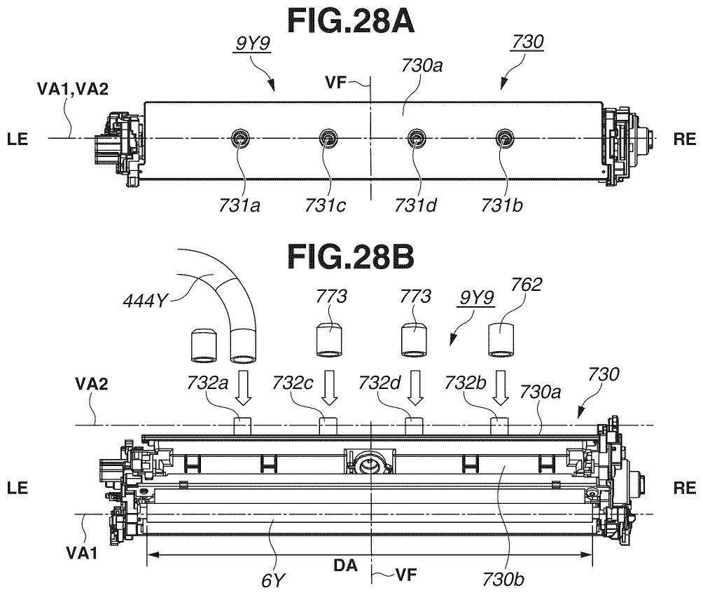

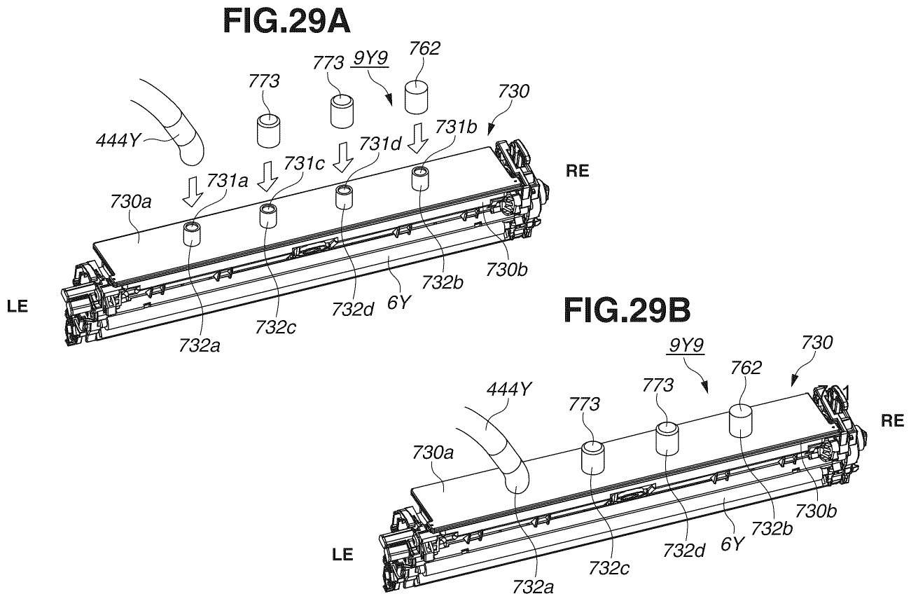

With reference to FIGS. 28A to 29B, characteristic portions according to a third embodiment of the present disclosure are described. FIG. 28A illustrates a top view of a development unit 9Y9. FIG. 28B illustrates a front view of the development unit 9Y9. FIG. 28B illustrates an assembly diagram with components to be assembled to the development unit 9Y9. FIG. 29A is a perspective view of the assembly of the development unit 9Y9. FIG. 29B is a perspective view after the assembly of the development unit 9Y9 is completed.

### Holes on Cover

As illustrated in FIG. 28B, a development unit 9Y9 includes a toner storage container 730 to which toner is supplied from a toner cartridge that is a toner replenishment container through the replenishment pipe 444Y that is a toner supply pipe. The toner storage container 730 includes a toner container 730b that rotatably supports the development roller 6Y, and a cover 730a that closes an opening of the toner container 730b.

The cover 730a is welded and joined to the opening of the toner container 730b.

As illustrated in FIG. 28B, the cover 730a includes a first hole 731a, a second hole 731b, a third hole 731c, and a fourth hole 731d that are through-holes at different positions on the virtual axis VA2 parallel to the rotating shaft VA1 of the development roller 6Y. The cover 730a also includes a first cylindrical portion 732a, a second cylindrical portion 732b, a third cylindrical portion 732c, and a fourth cylindrical portion 732d corresponding to these through-holes in a protruding manner. As illustrated in FIG. 28A, the shapes of these holes and the cylindrical portions 732a, 732b, 732c, and 732d are configured to be coaxial circles when viewed from above. The first cylindrical portion 732a and the second cylindrical portion 732b are placed symmetrically with respect to the longitudinal center VF of the toner bearing region DA of the development roller 6Y. The third cylindrical portion 732c and the fourth cylindrical portion 732d are placed symmetrically with respect to the longitudinal center VF of the toner bearing region DA of the development roller 6Y.

As illustrated in FIG. 29A, the replenishment pipe 444Y is attached to the first cylindrical portion 732a. The outer diameter of the first cylindrical portion 732a is set to be greater than the inner diameter of the replenishment pipe 444Y.

The inner diameter of the replenishment pipe 444Y is elastically deformable. Therefore, the replenishment pipe 444Y is assembled to the cylindrical portion 732a while expanding according to the outer diameter of the cylindrical portion 732a. As a result, the replenishment pipe 444Y fills the gap between assembling portions (the outer diameter and the inner diameter) of the components and prevents the leakage of toner from the assembling portions to outside.

### Air Exhaust Filter

A cap-like air exhaust filter 762 is attached to the second cylindrical portion 732b by a method such as welding, adhesion, or the like. Consequently, the toner T and the air are likely to flow into the development unit 9Y9 from the cartridge 430Y through the replenishment pipe 444Y similarly to the effects of the above air exhaust filter 761.

### Sealing Caps

Sealing caps 773 that seal toner in the toner storage container 730 are assembled to the third cylindrical portion 732c and the fourth cylindrical portion 732d.

The sealing caps 773 are each formed of an elastic member and are assembled to cover the third cylindrical portion 732c and the fourth cylindrical portion 732d. The inner diameters of the sealing caps 773 are elastically deformable, and the inner diameters are set to be smaller than the outer diameters of the third cylindrical portion 732c and the fourth cylindrical portion 732d. Consequently, the inner diameters of the sealing caps 773 elastically deform, and the sealing caps 773 are assembled to the third cylindrical portion 732c and the fourth cylindrical portion 732d by expanding relative to the outer diameters of the third cylindrical portion 732c and the fourth cylindrical portion 732d. As a result, the sealing caps 773 each fill the gap between assembling portions (the outer diameter and the inner diameter) of the components and prevent the leakage of toner from the assembling portions to outside.

FIG. 29B illustrates the state where the replenishment pipe 444Y, the air exhaust filter 762, and the sealing caps 773 are assembled to the development unit 9Y9. Then, the development unit 9Y9 in such a state is assembled to the drum unit 8Y, and a process cartridge is completed.

In the longitudinal direction of the development roller 6Y, the air exhaust filter 762 is placed in the second cylindrical portion 732b that is the furthest from the first cylindrical portion 732a in which the replenishment pipe 444Y is placed. In the longitudinal direction, a toner replenishment port and an air discharge port are placed as away from each other as possible. This results in the state where the flow of air occurs in the longitudinal direction in the toner storage container 730, and the circulation of toner is promoted.

As described in the second embodiment, an air exhaust filter 762 for increasing the air exhaust capability can also be added. The addition of a replenishment pipe 444 for replenishing toner from both ends can also be similarly employed in the present embodiment.

In other respects, in the third embodiment, it is possible to obtain effects similar to the effects described above in the first and second embodiments.

As illustrated in FIG. 28B, on the cover 730a, the holes are provided at different positions on the virtual axis VA2 parallel to the rotating shaft VA1 of the development roller 6Y. On the cover 730a, the first cylindrical portion 732a, the second cylindrical portion 732b, the third cylindrical portion 732c, and the fourth cylindrical portion 732d are provided corresponding to these holes. As illustrated in FIG. 28A, the shapes of these holes and the cylindrical portions 732a, 732b, 732c, and 732d are configured to be coaxial circles, viewed from above.

Consequently, the replenishment pipes 444, the air exhaust filters 762, and the sealing caps 773 may be selectively placed in the cylindrical portions (732a, 732b, 732c, and 732d) without increasing the number of components on the cover 730a.

Suppose that the shapes of the holes and the first cylindrical portion 732a, the second cylindrical portion 732b, the third cylindrical portion 732c, and the fourth cylindrical portion 732d are different from each other. Even in such a case, attachment portions of the replenishment pipes 444, the air exhaust filters 762, and the sealing caps 773 to be attached to the holes and the cylindrical portions 732a, 732b, 732c, and 732d are configured to correspond to the different shapes of these plurality of holes and the cylindrical portions 732a, 732b, 732c, and 732d. With this configuration, similarly, it is possible to selectively place the replenishment pipes 444, the air exhaust filters 762, and the sealing caps 773. If, however, the shapes of the holes and the cylindrical portions 732a, 732b, 732c, and 732d are the same, it is possible to simplify the shapes of the attachment portions of the replenishment pipes 444, the air exhaust filters 762, and the sealing caps 773 more.

The first cylindrical portion 732a and the second cylindrical portion 732b are placed symmetrically with respect to the longitudinal center VF of the toner bearing region DA of the development roller 6Y. The third cylindrical portion 732c and the fourth cylindrical portion 732d are placed symmetrically with respect to the longitudinal center VF of the toner bearing region DA of the development roller 6Y. Consequently, the replenishment pipes 444 may be configured to avoid the laser optical paths L located in the longitudinal centers. With this placement, it is possible to configure the replenishment pipes 444 to be short at both longitudinal ends.

As a result, it is possible to optimally replenish toner to the development units 9 while miniaturizing the main body 72.

In the first embodiment, an example of the configuration in which two holes (711a and 711b) are provided on the cover 710a has been illustrated. In the second and third embodiments, examples of the configurations in which four holes (721a, 721b, 721c, and 721d) are provided on the cover 720a and four holes (731a, 731b, 731c, and 731d) are provided on the cover 730a have been illustrated.

Also, if these holes are provided on the sides where the toner containers 710b, 720b, and 730b are located, rather than on the covers, it is possible to obtain effects similar to the above.

In the second and third embodiments, if a configuration may be employed in which three holes are placed by removing the fourth holes 721d and 722d, it is possible to selectively place the replenishment pipes 444 connected to the relay members 752, the air exhaust filters (761 and 762), and the sealing caps (772 and 773). Thus, it is possible to obtain effects similar to the above.

Also if a configuration is employed in which toner is conveyed by a screw rather than by compressed air, it is possible to obtain similar effects. If toner is conveyed by a screw, an air exhaust filter for exhausting compressed air does not necessarily need to be provided.

A cover of a yellow toner container may be referred to as a first cover member, and a portion other than the first cover member may be referred to as a first container. A cover of a cyan toner container may be referred to as a second cover member, and a portion other than the second cover member may be referred to as a second container. A cover of a magenta toner container may be referred to as a third cover member, and a portion other than the third cover member may be referred to as a third container. A cover of a black toner container may be referred to as a fourth cover member, and a portion other than the fourth cover member may be referred to as a fourth container.

First to third holes provided on the yellow cover may be referred to as a first through-hole, a second through-hole, and a fifth through-hole, respectively, in order from the LE side. First to third holes provided on the cyan cover may be referred to as a third through-hole, a fourth through-hole, and a sixth through-hole, respectively, in order from the LE side. First to third holes provided on the magenta cover may be referred to as a seventh through-hole, an eighth through-hole, and a ninth through-hole, respectively, in order from the LE side.

The rotational axis of a yellow development roller may be referred to as a first rotational axis, the rotational axis of a cyan development roller may be referred to as a second rotational axis, the rotational axis of a magenta development roller may be referred to as a third rotational axis, and the rotational axis of a black development roller may be referred to as a fourth rotational axis.

The direction Y may be referred to as a first direction, the direction X may be referred to as a second direction, and the direction Z may be referred to as a third direction.

An end portion on the LE side of the yellow toner container may be referred to as a first end portion, and an end portion on the opposite side may be referred to as a second end portion. An end portion on the LE side of the cyan toner container may be referred to as a third end portion, and an end portion on the opposite side may be referred to as a fourth end portion.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-194023, filed Nov. 5, 2024, which is hereby incorporated by reference herein in its entirety.

What is claimed is:

1. An image forming apparatus comprising:
a first toner container configured to store first toner, the first toner container including a first discharge port for discharge of the first toner;
a second toner container configured to store second toner, the second toner container including a second discharge port for discharge of the second toner;
a first development unit including a first development container configured to store the first toner, the first development unit including a first development roller configured to bear the first toner stored in the first development container;
a second development unit including a second development container configured to store the second toner, the second development unit including a second development roller configured to bear the second toner;
a first passage configured to convey the first toner discharged from the first discharge port toward the first development container, wherein one end of the first passage communicates with the first discharge port of the first toner container and another end of the first passage communicates with the first development container; and
a second passage configured to convey the second toner discharged from the second discharge port toward the second development container, wherein one end of the second passage communicates with the second discharge port of the second toner container and another end of the second passage communicates with the second development container,
wherein the first development container includes a first frame, which forms a first space configured to store the first toner, with a first through-hole and a second through-hole provided in the first frame,
wherein the second development container includes a second frame, which forms a second space configured to store the second toner, with a third through-hole and a fourth through-hole corresponding to the first through-hole and the second through-hole, respectively, provided in the second frame,
wherein the other end of the first passage communicates with the first space of the first development container through the first through-hole,
wherein the other end of the second passage communicates with the second space of the second development container through the fourth through-hole, and
wherein the second through-hole and the third through-hole are sealed.

2. The image forming apparatus according to claim 1,
wherein the first development container includes a first container forming the first space with the first frame, provided below the first frame, and including a first opening that opens upward,
wherein the second development container includes a second container forming the second space with the second frame and provided below the second frame, and
wherein the first frame is configured as a first cover member that closes an opening of the first container, and the second frame is configured as a second cover member that closes an opening of the second container.

3. The image forming apparatus according to claim 1,
wherein the first development roller is configured to rotate about a first rotational axis extending in a first direction,
wherein the second development roller is configured to rotate about a second rotational axis extending in the first direction,
wherein the first through-hole and the second through-hole are provided in a first end portion of the first development container in the first direction and a second end portion on a side opposite to the first end portion in the first direction, respectively, and
wherein the third through-hole and the fourth through-hole are provided in a third end portion of the second development container in the first direction on a same side as the first end portion in the first direction, and a fourth end portion on the opposite side of the third end portion and on a same side as the second end portion in the first direction, respectively.

4. The image forming apparatus according to claim 3,
wherein the first and second development containers are aligned in a second direction orthogonal to the first direction,
wherein the first and second toner containers are aligned in the first direction, and
wherein in the first direction, the first toner container is provided at a position closer to the first end portion than the second end portion, and the second toner container is provided at a position closer to the second end portion than the first end portion.

5. The image forming apparatus according to claim 1, further comprising:
a first pump configured to discharge air for conveying the first toner conveyed through the first passage; and
a second pump configured to discharge air for conveying the second toner conveyed through the second passage.

6. The image forming apparatus according to claim 1, wherein, when viewed in a rotational axis direction of a rotating shaft of the first development roller, the first and second through-holes overlap.

7. The image forming apparatus according to claim 1, wherein:
the first frame and the second frame have a same shape, and
the first and second through-holes have a same shape.

8. The image forming apparatus according to claim 2, further comprising a filter configured to separate air for conveying the first toner from the first toner container and discharge air from the first development container,
wherein the filter is configured to cover the second through-hole of the first cover member, to prevent the first toner from passing through the filter, and to allow the air to pass through the filter.

9. The image forming apparatus according to claim 1, further comprising:
a third toner container configured to store third toner, the third toner container including a third discharge port for discharge of the third toner;
a third development unit including a third development container configured to store the third toner, the third development unit including a third development roller configured to bear the third toner stored in the third development container;
a third passage configured to convey the third toner discharged from the third discharge port toward the third development container, wherein one end of the third passage communicates with the third discharge port and another end of the third passage communicates with the third development container;
a fifth through-hole provided in the first frame of the first development container; and
a sixth through-hole provided in the second frame of the second development container,
wherein the third development container includes a third frame, which forms a third space configured to store the third toner, the third frame having a same shape as the first frame, with a seventh through-hole corresponding to the first through-hole, an eighth through-hole corresponding to the second through-hole, and a ninth through-hole corresponding to the fifth through-hole provided therein, and
wherein the other end of the third passage communicates with the third space of the third development container through the ninth through-hole.

10. The image forming apparatus according to claim 9, wherein the first development container includes a sealing cap configured to seal the fifth through-hole of the first frame.

11. The image forming apparatus according to claim 1, further comprising a first relay member between the other end of the first passage and the first through-hole,
wherein the first relay member includes an opening, and the other end of the first passage and the first through-hole are configured to communicate through the opening.

12. The image forming apparatus according to claim 1, further comprising a first pump configured to discharge air for conveying the first toner through the first passage,
wherein the first frame of the first development container includes:
a fifth through-hole; and
a filter configured to separate air for conveying the first toner from the first toner and discharge the air to outside the first development container, the filter placed to cover the fifth through-hole and configured to prevent the first toner from passing through the filter and allow the air to pass through the filter, and
wherein the first through-holes, the second through-holes, and the fifth through-hole overlap a virtual line parallel to a rotational axis direction of a rotating shaft of the first development roller, and are offset in the rotational axis direction.

13. The image forming apparatus according to claim 2, wherein a volume of the second space is greater than a volume of the first space due to a difference between shapes of the first container and the second container.
